(19) United States
(12) Patent Application Publication
(10) Pub. No.: US 2026/0233499 A1
(43) Pub. Date: Aug. 13, 2026

(54) LAMINATE, MOLDED BODY INCLUDING SAME, AND METHOD FOR MANUFACTURING MOLDED BODY

(71) Applicant: KANEKA CORPORATION, Osaka (JP)

(72) Inventors: Hanako Hasebe, Osaka (JP); Fujio Ishimaru, Osaka (JP); Haruki Koyama, Osaka (JP); Katsumi Yamaguchi, Hyogo (JP); Yukihiro Shimamoto, Tokyo (JP)

(73) Assignee: KANEKA CORPORATION, Osaka (JP)

(21) Appl. No.: 19/433,609

(22) Filed: Dec. 26, 2025

Related U.S. Application Data
(63) Continuation of application No. PCT/JP2024/021666, filed on Jun. 14, 2024.

(30) Foreign Application Priority Data
Jun. 28, 2023 (JP) 2023-106289

(51) Int. Cl. B32B 27/08; B32B 27/30; B32B 27/40

(52) U.S. Cl. CPC B32B 27/08; B32B 27/308; B32B 27/40; B32B 2307/712; B32B 2307/737; B32B 2571/00

(57) ABSTRACT

A laminate includes a substrate layer including an acrylic resin film and a cured resin layer. The acrylic resin film has a tensile elongation at break of 200% or more at 120° C. The cured resin layer is formed from a cured product of an active energy ray curable resin composition containing a urethane acrylate resin. A cure index of the cured resin layer represented by Formula 1 is 0.013 or less. Formula 1 is expressed as: Cure index=B/D where B represents the area of an infrared absorption peak at a wavenumber of about 810 cm⁻¹ in FT-IR measurement of the cured resin layer, and D represents the area of an infrared absorption peak at a wavenumber of about 1705 cm⁻¹ in FT-IR measurement of the cured resin layer. The laminate has a tensile crack elongation of 80% or more at 120° C.

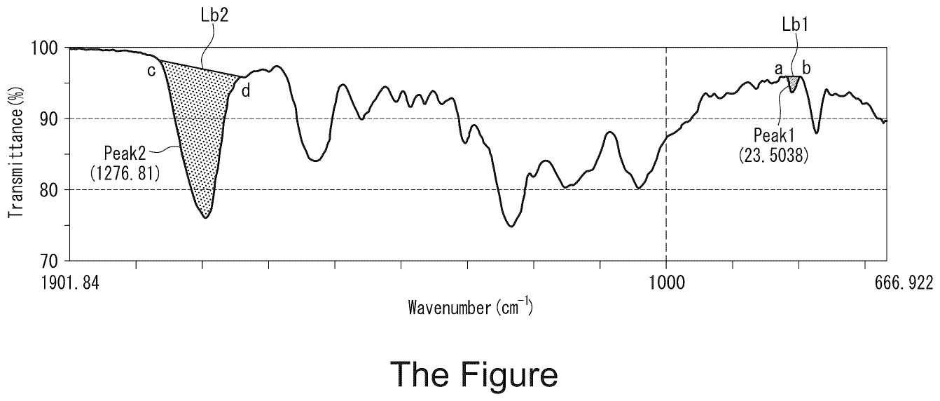

### TECHNICAL FIELD

One or more embodiments of the present invention relate to a laminate including an acrylic resin film, a molded body including the laminate, and a method for manufacturing the molded body.

### BACKGROUND

Acrylic resin films including elastic bodies and obtained by molding an acrylic resin composition are used in a variety of applications, taking advantage of their excellent properties such as transparency, hardness, weather resistance, and secondary moldability. Examples of applications of such acrylic resin films include decorative and protective applications as an alternative to painting on interior or exterior members of vehicles, decorative and protective applications for exterior members of electronic devices such as portable electronic devices, personal computers, and home appliances, and applications as building members.

When acrylic resin films are used to decorate and protect vehicle interior and exterior members, as well as electronic devices such as portable electronic devices, personal computers, and home appliances, the acrylic resin films need to have sufficient scratch resistance and surface hardness for surface protection, as well as high secondary moldability for uniform lamination onto the surface of a target product, including products having three-dimensional shapes. For example, Patent Document 1 proposes a technique by which both secondary moldability and scratch resistance are obtained by providing, on the surface of an acrylic resin film substrate, a hard coat layer exhibiting high surface hardness after curing and high secondary moldability.

On the other hand, in these applications, products often come into contact with the human body, and when sunscreens or insect repellents are applied to human skin in summer or in hot regions, the sunscreens or insect repellents may adhere to the product surface, which may cause, for example, deterioration of the product surface. Thus, the acrylic resin films also need to have resistance to them. For example, N,N-diethyl-3-ethylbenzamide (hereinafter also referred to as DEET) has little influence on the human body and is highly effective as a repellent against harmful insects such as mosquitoes, and thus is widely used as a main component in insect repellent sprays and lotions. However, in many plastic products containing an acrylic resin, when the skin of a person who has applied an insect repellent containing DEET to the skin comes into contact with those products, the DEET contained in the insect repellent adheres to the surfaces of the plastic products, and thus corrodes the product surfaces and causes deterioration in the appearance of the products. In view of this, Patent Document 2 proposes a laminated film having a certain degree of resistance to DEET due to a cured resin layer made of a resin containing units derived from a urethane resin being provided on an acrylic resin film.

### PATENT DOCUMENTS

[Patent Document 1] WO 2022/137768
[Patent Document 2] WO 2016/199847

However, in recent years, in order to increase the durability of insect repellent effects, for example, in Japan, it is now permitted to incorporate DEET in insect repellents at high concentrations of up to 30%, and there is a growing demand for preventing the surfaces of products containing acrylic resin films from deteriorating due to DEET. There is a demand for an acrylic resin film that is resistant to chemical material containing DEET at such high concentrations.

### SUMMARY

One or more embodiments of the present invention have been made in view of the above, and provides a laminate that includes an acrylic resin film and has high surface hardness and secondary moldability as well as favorable chemical resistance to chemicals such as N,N-diethyl-3-ethylbenzamide; a molded body including the laminate, and a method for manufacturing the molded body.

One or more embodiments of the present invention relate to a laminate including a substrate layer; and a cured resin layer, wherein the substrate layer includes an acrylic resin film, the acrylic resin film has a tensile elongation at break of 200% or more at 120° C., the cured resin layer is formed from a cured product of an active energy ray curable resin composition containing a urethane acrylate resin, a cure index of the cured resin layer represented by a formula 1 below is 0.013 or less, and the laminate has a tensile crack elongation of 80% or more at 120° C.,

$$Cure index = B / D \qquad [ Formula 1 ]$$

in the formula 1 above, B represents an area of an infrared absorption peak at a wavenumber of about 810 cm⁻¹ in FT-IR measurement of the cured resin layer, and D represents an area of an infrared absorption peak at a wavenumber of about 1705 cm⁻¹ in FT-IR measurement of the cured resin layer.

One or more embodiments of the present invention relate to a molded body including the laminate and a molded body substrate, wherein the laminate is laminated on a surface of the molded body substrate, and the cured resin layer of the laminate is located on a surface side of the molded body relative to the substrate layer of the laminate.

One or more embodiments of the present invention relate to a method for manufacturing the molded body, the method comprising laminating the laminate on the surface of the molded body substrate using one or more methods selected from the group consisting of vacuum molding, pressure molding, film insert injection molding, and three-dimensional lamination molding.

According to one or more embodiments of the present invention, it is possible to provide a laminate that includes an acrylic resin film and has high surface hardness and secondary moldability as well as favorable chemical resistance to chemicals such as N,N-diethyl-3-ethylbenzamide, a molded body including the laminate, and a method for manufacturing the molded body.

### BRIEF DESCRIPTION OF THE DRAWING

The FIGURE is a diagram illustrating a method for calculating a cure index based on the area of the infrared absorption peak at a wavenumber of about 810 cm⁻¹, and the area of the infrared absorption peak at a wavenumber of about 1705 cm⁻¹, in FT-IR measurement of a cured resin layer in Comparative Example 2.

### DETAILED DESCRIPTION

Inventors of one or more embodiments of the present invention have conducted intensive studies to resolve the above. As a result, the inventors found that in a laminate including a cured resin layer and a substrate layer including an acrylic resin film, by using an acrylic resin film having a tensile elongation at break of 200% or more at 120° C., setting the tensile crack elongation of the laminate at 120° C. to 80% or more, forming the cured resin layer from a cured product of an active energy ray curable resin composition containing a urethane acrylate resin, and setting the value of the cure index of the cured resin layer represented by the formula 1 below to a specific range, i.e., the degree of curing to a specific range, the surface hardness and secondary moldability of the laminate can be increased, and chemical resistance to high concentrations of DEET can be enhanced.

$$Cure index = B / D \qquad [ Formula 1 ]$$

In the formula 1 above, B represents the area of the infrared absorption peak at a wavenumber of about 810 cm⁻¹ in FT-IR measurement of the cured resin layer, and D represents the area of the infrared absorption peak at a wavenumber of about 1705 cm⁻¹ in FT-IR measurement of the cured resin layer.

In this specification, the cure index is a parameter that indicates the degree of curing of the cured resin layer, and more specifically, it depends on the degree of progress of the curing reaction in the active energy ray curable resin composition containing a urethane acrylate resin. In the FT-IR measurement, the infrared absorption peak at a wavenumber of about 810 cm⁻¹ corresponds to out-of-plane bending vibration of the C—C double bond of the acryloyl group and/or the methacryloyl group. B reflects the content of uncured acryloyl and methacryloyl groups in the cured resin layer, and its value decreases as the curing reaction progresses. In the FT-IR measurement, the infrared absorption peak at a wavenumber of about 1705 cm⁻¹ corresponds to stretching vibration of the C—O double bond of the ester group. D reflects a total amount of uncured acryloyl and methacryloyl groups in the cured resin layer, as well as the ester groups after the acryloyl and methacryloyl groups have undergone a curing reaction, and in principle, the total amount of C—O double bond functional groups does not change before and after the curing reaction. The cure index B/D is obtained by dividing the peak area value corresponding to the acryloyl groups and the methacryloyl groups, which are functional groups that decrease in number through the curing reaction, by the peak area value that does not change in principle through the curing reaction. The cure index depends on the degree of progress of the curing reaction, takes the maximum value when the curing reaction has not started yet and reaches 0 when the curing reaction has completely progressed, and can be used as a parameter indicating the degree of curing of the cured resin layer.

In one or more embodiments of the present invention, by setting, to 0.013 or less, the cure index B/D of the cured resin layer formed from the cured product of the active energy ray curable resin composition containing a urethane acrylate resin, the chemical resistance to high concentrations of DEET, for example, 30 w/v %, is improved.

In vehicle interior members such as automobile interior members, dashboards, door trims, and the like have portions that are exposed to sunlight through window glass. Thus, these interior members are required to have weather resistance (resistance to ultraviolet degradation) at relatively high temperatures caused by exposure to sunlight such that their surfaces do not deteriorate over long periods of use. Acrylic resin films are widely used as decorative surface members for the surfaces of automobile interior members, for example, using insert or in-mold decorative molding techniques, and have excellent weather resistance in addition to high secondary moldability. However, when a hard coat or chemical resistant coating is applied for surface hardness and chemical resistance, the weather resistance may be impaired. In one or more embodiments of the present invention, by setting the cure index B/D to 0.013 or less and by adding, to an active energy ray curable resin composition, a hindered amine light stabilizer having a reactive functional group and a compound having a hydrophobic group and a reactive functional group in addition to a urethane acrylate resin, it is possible to improve weather resistance, in particular, weather resistance of physical properties including chemical resistance to chemicals such as DEET.

In the present specification, a numerical range indicated by “ . . . to . . . ” includes two end values (upper and lower limits). For example, a numerical range indicated by “X to Y” includes two end values of X and Y, and is the same range as “X or more and Y or less”. In addition, any number within the above range or any range included in the range is specifically disclosed. Also, in the present specification, when a plurality of numerical ranges are mentioned, the numerical ranges include appropriate combinations of upper and lower limits of different numerical ranges.

### (Acrylic Resin Film)

An acrylic resin film has a tensile elongation at break of 200% or more at 120° C. This increases the tensile crack elongation at 120° C. of the laminate with the cured resin layer and tends to improve the secondary moldability of the laminate. There is no particular limitation on the upper limit of the tensile elongation at break of the acrylic resin film at 120° C. In the present specification, the tensile elongation at break of the acrylic resin film at 120° C. can be measured using the method described in the examples.

The acrylic resin film may be formed from an acrylic resin composition containing an acrylic resin and graft copolymer particles containing a rubber component (also referred to as a cross-linked elastomer).

### <Acrylic Resin>

Conventionally known acrylic resins can be used as the acrylic resin as appropriate. For example, from the viewpoint of hardness and moldability, it is preferable to use an acrylic resin (also referred to as a thermoplastic acrylic polymer) containing methyl methacrylate units in an amount of 50% by mass to 100% by mass and other constitutional units in an amount of 0% by mass to 50% by mass, where a total amount of the constitutional units of the acrylic resin is 100% by mass. Note that a total amount of methyl methacrylate units and other constitutional units in the thermoplastic acrylic polymer is 100% by mass.

Examples of the other constitutional units include constitutional units derived from acrylic acid, acrylic acid derivatives, methacrylic acid, methacrylic acid derivatives, aromatic vinyl derivatives, and vinyl cyanide derivatives. The other constitutional units may be, for example, a glutarimide structure, a lactone ring structure, a structure based on N-substituted maleimide, and a structure based on unsubstituted maleimide, which will be described later. The other structural units contained in the acrylic resin may be of one type or a combination of two or more types.

Examples of the acrylic acid derivatives include, but are not limited to, acrylic acid esters such as methyl acrylate, ethyl acrylate, n-propyl acrylate, n-butyl acrylate, isobutyl acrylate, cyclohexyl acrylate, 2-hydroxyethyl acrylate, 2-phenoxyethyl acrylate, benzyl acrylate, and glycidyl acrylate.

Examples of the methacrylic acid derivatives include, but are not limited to, methacrylic acid esters such as ethyl methacrylate, n-propyl methacrylate, n-butyl methacrylate, isobutyl methacrylate, phenyl methacrylate, benzyl methacrylate, cyclohexyl methacrylate, 2-phenoxyethyl methacrylate, and isobornyl methacrylate, as well as reactive ultraviolet absorbers described below.

Examples of the aromatic vinyl derivatives include, but are not limited to, styrene, vinyltoluene, and α-methylstyrene.

Examples of the vinyl cyanide derivatives include, but are not limited to, acrylonitrile and methaycrylonitrile.

In order to improve the heat resistance, rigidity, surface hardness, and the like of the acrylic resin, a constitutional unit having a specific structure may be introduced into the acrylic resin through copolymerization, functional group modification, denaturation, or the like. Examples of such specific structures include glutarimide structures as shown in JP S62-89705A, JP H02-178310A, WO 2005/54311, and the like, lactone ring structures as shown in JP 2004-16882A, JP 2006-171464A, and the like, glutaric anhydride structures obtained through thermal cyclocondensation of (meth)acrylic acid units as shown in JP 2004-307834A and the like, maleic anhydride structures as shown in JP H5-119217A, and structures based on N-substituted maleimide and structures based on unsubstituted maleimide as shown in WO 2009/84541. For example, by introducing these structures into acrylic resin, molecular chains become rigid. As a result, it is expected that the acrylic resin has effects such as improved heat resistance, improved surface hardness, reduced heat shrinkage, and improved chemical resistance.

There is no particular limitation on a method for manufacturing an acrylic resin, and for example, known polymerization methods such as a suspension polymerization method, a bulk polymerization method, a solution polymerization method, and an emulsion polymerization method can be used. In addition, any of known radical polymerization method, living radical polymerization method, anionic polymerization method, and cationic polymerization method can be used.

In 100% by mass of the acrylic resin film, the content of the acrylic resin may be 20% by mass to 100% by mass, 20% by mass to 99% by mass, 25% by mass to 95% by mass, or 30% by mass to 90% by mass.

### <Graft Copolymer Containing Rubber Component>

The acrylic resin film may contain, as graft copolymer particles containing a rubber component, graft copolymer particles (A) having an average particle size of 20 to 200 nm. In this case, in the acrylic resin film, the graft copolymer particles (A) may be dispersed in a matrix containing an acrylic resin or an acrylic resin and other components.

In addition, the acrylic resin film may contain, as graft copolymer particles containing a rubber component, in addition to the graft copolymer particles (A), graft copolymer particles (B) having an average particle size larger than that of the graft copolymer particles (A) as needed. In this case, in the acrylic resin film, the graft copolymer particles (A) and the graft copolymer particles (B) may be dispersed in a matrix containing an acrylic resin or an acrylic resin and other components.

The graft copolymer particles (A) may have a core-shell structure (multilayer structure) including a cross-linked elastomer (A1) that is a rubber component and a graft polymer layer (A2) located on the surface layer side relative to the cross-linked elastomer (A1).

The cross-linked elastomer (A1) may be a known cross-linked elastomer. The cross-linked elastomer (A1) may be an acrylic acid ester-based cross-linked elastomer (a cross-linked elastomer constituted by a polymer containing an acrylic acid ester as a main component). In the present specification, the term “main component” refers to a component whose content is 50% by mass or more.

Particles of the acrylic acid ester-based cross-linked elastomer (A1) may have a concentric spherical multilayer structure having a hard cross-linked resin layer having a glass transition temperature of room temperature (20° C.±5° C.) or higher, or a semi-hard cross-linked resin layer having a glass transition temperature in a range of 0° C. to room temperature, inside the cross-linked elastomer layer. Examples of such hard or semi-hard cross-linked resin layers include hard cross-linked methacrylic resin particles as described in JP S55-27576A and the like, semi-hard cross-linked particles made of methyl methacrylate-acrylic acid ester-styrene as described in JP H4-270751A, and cross-linked rubber particles having a high degree of cross-linking. When the cross-linked elastomer particles include such a hard or semi-hard cross-linked resin layer, improvements in transparency, color tone, and the like can be expected in some cases.

The graft copolymer particles (A) may have a core-shell structure formed by graft-polymerizing a monomer mixture that forms the graft polymer layer (A2) in the presence of particles of the above-described acrylic acid ester-based cross-linked elastomer (A1)

The average particle size of the graft copolymer particles (A) may be 50 to 150 nm, or 50 to 120 nm. If the average particle size of the graft copolymer particles (A) is too small, the impact resistance and bending crack resistance of the acrylic resin film tend to decrease. If the average particle size of the graft copolymer particles (A) is too large, the transparency of the acrylic resin film tends to deteriorate and whitening tends to occur when the acrylic resin film is bent.

It is preferable to use, as the acrylic acid ester-based cross-linked elastomer (A1), cross-linked elastomer particles obtained by polymerizing a monomer mixture (a-1) containing (a) an acrylic acid ester, (b) a polyfunctional monomer copolymerizable with the acrylic acid ester and having two or more non-conjugated double bonds per molecule, and (c) any other vinyl-based monomer copolymerizable with the acrylic acid ester.

The acrylic acid ester, the polyfunctional monomer, and the other vinyl-based monomer may all be mixed together and polymerized in one step. In addition, for the purpose of adjusting the toughness, whitening resistance, and the like of the acrylic resin film, compositions of the acrylic acid ester, the polyfunctional monomer, and the other vinyl-based monomer may be changed as appropriate, or the compositions may be kept the same, and the acrylic acid ester, the polyfunctional monomer, and the other vinyl-based monomer may be polymerized in two or more steps.

From the viewpoint of obtaining a polymer that has high polymerizability, is inexpensive, and has a low glass transition temperature (Tg), and the like, an aliphatic ester of acrylic acid is preferable as an acrylic acid ester, an acrylic acid aliphatic alkyl ester is more preferable, and an acrylic acid aliphatic alkyl ester whose alkyl group has 1 to 22 carbon atoms is particularly preferable. The aliphatic alkyl may be linear, branched, or cyclic (also referred to as alicyclic).

Specific examples of acrylic acid aliphatic alkyl esters may include methyl acrylate, ethyl acrylate, propyl acrylate, n-butyl acrylate, isobutyl acrylate, 2-ethylhexyl acrylate, n-octyl acrylate, isobornyl acrylate, cyclohexyl acrylate, dodecyl acrylate, stearyl acrylate, heptadecyl acrylate, and octadecyl acrylate. These may be used alone or in combination of two or more.

The amount of the acrylic acid ester (which may be an acrylic acid aliphatic alkyl ester, or an acrylic acid aliphatic alkyl ester whose alkyl group has 1 to 22 carbon atoms) may be 50% by mass to 99.9% by mass, 70% by mass to 99% by mass, or 80% by mass to 99% by mass, when the amount of the monomer mixture (a-1) is 100% by mass. When the amount of the acrylic acid ester is 50% by mass or more, the acrylic resin film has good impact resistance and good tensile elongation at break, and is less susceptible to cracking during secondary molding.

Examples of the other vinyl-based monomer include methacrylic acid esters such as methyl methacrylate, ethyl methacrylate, propyl methacrylate, n-butyl methacrylate, isobutyl methacrylate, t-butyl methacrylate, phenyl methacrylate, benzyl methacrylate, cyclohexyl methacrylate, phenoxyethyl methacrylate, isobornyl methacrylate, and dicyclopentenyl methacrylate; vinyl cyanide derivatives such as acrylonitrile and methacrylonitrile; aromatic vinyl derivatives such as styrene, vinyl toluene, and a-methylstyrene; acrylic acid; acrylic acid derivatives other than acrylic acid aliphatic alkyl esters such as phenyl acrylate and benzyl acrylate; methacrylic acid; methacrylic acid derivatives such as β-hydroxyethyl methacrylate, dimethylaminoethyl methacrylate, and glycidyl methacrylate; maleic anhydride; and maleic acid derivatives such as N-alkylmaleimide and N-phenylmaleimide. These may be used alone or in combination of two or more. In particular, from the viewpoint of weather resistance and transparency, the other vinyl-based monomer may be one or more monomers selected from the group consisting of methacrylic acid esters and aromatic vinyl derivatives.

In 100% by mass of the monomer mixture (a-1), the amount of the other vinyl-based monomer may be 0% by mass to 49.9% by mass, 0% by mass to 30% by mass, or 0% by mass to 20% by mass. When the amount of the other vinyl-based monomer exceeds 49.9% by mass, the impact resistance of the acrylic resin film is likely to decrease, tensile elongation at break is reduced, and a crack is likely to form during secondary molding in some cases.

It is possible to suitably use a monomer that is usually used as a cross-linking agent and/or a graft cross-linking agent as a polyfunctional monomer. It is possible to use, as the polyfunctional monomer, for example, allyl methacrylate, allyl acrylate, triallyl cyanurate, triallyl isocyanurate, diallyl phthalate, diallyl maleate, divinyl adipate, divinyl benzene, ethylene glycol dimethacrylate, propylene glycol dimethacrylate, diethylene glycol dimethacrylate, triethylene glycol dimethacrylate, trimethylolpropane trimethacrylate, polyethylene glycol dimethacrylate, and dipropylene glycol dimethacrylate. These polyfunctional monomers may be used alone or in combination of two or more.

The polyfunctional monomers that function as a graft cross-linking agent are more preferable because such polyfunctional monomers increase the number of graft bonds in a later-described graft polymer layer (A2) to a cross-linked elastomer (A1), resulting in good dispersibility of the graft copolymer particles (A) in the acrylic resin, improving crack resistance against tension and bending deformation, and reducing stress whitening. As such a polyfunctional monomer that functions as a graft cross-linking agent, a polyfunctional monomer having an allyl group such as allyl methacrylate, allyl acrylate, triallyl cyanurate, triallyl isocyanurate, diallyl phthalate, and diallyl maleate are preferable, and allyl methacrylate, allyl acrylate, and the like are particularly preferable.

The amount of the polyfunctional monomer may be 0.1% by mass to 10% by mass, or 1.0% by mass to 4% by mass, in 100% by mass of the monomer mixture (a-1). From the viewpoint of the resistance to cracking and whitening caused by bending the acrylic resin film, and the fluidity of the resin during molding, the blend amount of the polyfunctional monomer may be within the above range.

For the purpose of increasing a graft covering efficiency of a later-described graft polymer layer (A2), the amount of the polyfunctional monomer in the acrylic acid ester-based cross-linked elastomer (A1) may be changed between the inside and the vicinity of the surface of the cross-linked elastomer (A1). Specifically, as described in Japanese Patent No. 1460364, Japanese Patent No. 1786959, and the like, if the content of the polyfunctional monomer that functions as a graft cross-linking agent in the vicinity of the surface of the cross-linked elastomer (A1) is larger than that in the inside of the cross-linked elastomer (A1), it is possible to improve a coverage of the graft copolymer particles (A) with a graft polymer layer, improve dispersibility in the acrylic resin, and suppress a decrease in crack resistance due to peeling at the interface between the graft copolymer particles (A) and the acrylic resin. Furthermore, since a sufficient coverage can be obtained by a relatively small amount of the graft polymer layer (A2), it is expected that the blend amount of the graft copolymer particles (A) to introduce a predetermined amount of the cross-linked elastomer (A1) to the acrylic resin composition can be reduced, and therefore the melt viscosity of the acrylic resin composition can be reduced, and the melt processability, film processing accuracy, and surface hardness, and the like of the acrylic resin film can be improved.

A chain transfer agent may be used in addition to the monomer mixture (a-1), for the purpose of controlling the molecular weight and crosslink density of the acrylic acid ester-based cross-linked elastomer (A1) and for the purpose of controlling the thermal stability and the like by reducing the double bond terminals of the polymer accompanying the disproportionation termination reaction during polymerization. The chain transfer agent can be selected from agents usually used in radical polymerization. For example, monofunctional or polyfunctional mercaptan compounds having 2 to 20 carbon atoms, such as n-octyl mercaptan, n-dodecyl mercaptan, and t-dodecyl mercaptan; mercapto acids; thiophenol; carbon tetrachloride; or mixtures thereof are preferable as chain transfer agents. The amount of the chain transfer agent added may be 0 to 1.0 parts by mass, or 0 to 0.2 parts by mass, with respect to 100 parts by mass of the total amount of the monomer mixture (a-1).

Particles of the cross-linked elastomer (A1) may have a single layer structure constituted by the above-described acrylic acid ester-based cross-linked elastomer (A1), or may have a multilayer structure including two or more layers constituted by the above-described acrylic acid ester-based cross-linked elastomer (A1).

The particles of the cross-linked elastomer (A1) may have a multilayer structure in which at least one layer of the multilayer particles having a hard or semi-hard cross-linked resin layer contains the acrylic acid ester-based cross-linked elastomer (A1). Examples of monomers constituting the hard or semi-hard cross-linked resin layer include methacrylic acid esters such as methyl methacrylate, ethyl methacrylate, n-butyl methacrylate, isobutyl methacrylate, t-butyl methacrylate, benzyl methacrylate, and phenoxyethyl methacrylate; acrylic acid alkyl esters such as methyl acrylate, ethyl acrylate, propyl acrylate, n-butyl acrylate, isobutyl acrylate, t-butyl acrylate, 2-ethylhexyl acrylate, and n-octyl acrylate; aromatic vinyl derivatives such as styrene and α-methylstyrene; vinyl cyanide derivatives such as acrylonitrile; maleic anhydride; maleic acid derivatives such as maleimides; and polyfunctional monomers having two or more non-conjugated double bonds per molecule. Polyfunctional monomers that are similar to those used in the polymerization of the acrylic acid ester-based cross-linked elastomer (A1) layer can be used as the polyfunctional monomer. In particular, one or more selected from the group consisting of methyl methacrylate, n-butyl methacrylate, isobutyl methacrylate, t-butyl methacrylate, ethyl acrylate, n-butyl acrylate, isobutyl acrylate, t-butyl acrylate, styrene, acrylonitorile, and the like are preferable. During the polymerization of a hard or semi-hard cross-linked resin layer, in addition to these monomers, a chain transfer agent may be used in combination for the purpose of controlling the crosslink density and for the purpose of controlling the thermal stability and the like by reducing the double bond terminals of a polymer. Chain transfer agents that are similar to those used in the polymerization of the acrylic acid ester-based cross-linked elastomer (A1) layer can be used as the chain transfer agent. The amount of the chain transfer agent added may be 0 to 2 parts by mass, or 0 to 0.5 parts by mass, with respect to 100 parts by mass of the total amount of the monomer mixture that constitutes the hard or semi-hard cross-linked resin layer.

When the graft copolymer particles (A) have a two-layer structure of cross-linked elastomer (A1) particles serving as core particles and a graft polymer layer (A2), which is a shell layer, the graft copolymer particles (A) can be typically obtained by graft copolymerizing a monomer mixture (a-2) containing a methacrylic acid ester in an amount of 50% by mass to 100% by mass and another vinyl-based monomer copolymerizable with the methacrylic acid ester in an amount of 0% by mass to 50% by mass (provided that the total of the methacrylic acid ester and the other vinyl-based monomer is 100% by mass) in the presence of the particles of the cross-linked elastomer (A1) to form the graft polymer layer (A2).

The amount of the methacrylic acid ester in 100% by mass of the monomer mixture (a-2) may be 60% by mass or more, 80% by mass or more, 90% by mass or more, or 97% by mass or more, from the viewpoint of (a) ensuring compatibility with an acrylic resin matrix, and (b) suppressing a decrease in the toughness of the film due to solvent impregnation while the acrylic resin film is coated, and suppressing whitening and cracking caused by stretch of the film during molding.

In the monomer mixture (a-2), examples of the methacrylic acid ester include methacrylic acid alkyl esters such as methyl methacrylate, ethyl methacrylate, propyl methacrylate, n-butyl methacrylate, isobutyl methacrylate, t-butyl methacrylate, hexyl methacrylate, cyclohexyl methacrylate, 2-ethylhexyl methacrylate, and octyl methacrylate, and aromatic methacrylic acid esters such as phenyl methacrylate and benzyl methacrylate. In particular, a methacrylic acid alkyl ester whose alkyl group has 1 to 4 carbon atoms is preferable.

In the monomer mixture (a-2), an acrylic acid alkyl ester whose alkyl group has 2 or more carbon atoms can be used as the other vinyl-based monomer. The acrylic acid alkyl ester whose alkyl group has 2 or more carbon atoms may be, for example, one or more selected from the group consisting of ethyl acrylate, propyl acrylate, n-butyl acrylate, isobutyl acrylate, t-butyl acrylate, hexyl acrylate, cyclohexyl acrylate, octyl acrylate, dodecyl acrylate, and stearyl acrylate, and the like, one or more selected from the group consisting of ethyl acrylate, n-butyl acrylate, isobutyl acrylate, and t-butyl acrylate, or n-butyl acrylate.

In the monomer mixture (a-2), it is also possible to use, as the other vinyl-based monomer, aromatic vinyl derivatives such as styrene and its nuclear-substituted derivatives, vinyl cyanide derivatives such as acrylonitrile, methacrylic acid, methacrylic acid derivatives, acrylic acid, acrylic acid derivatives, N-substituted maleimides, maleic anhydride, methacrylamide, acrylamide, and the like.

The monomer mixture (a-2) may contain a reactive ultraviolet absorber as the other vinyl-based monomer. That is, the graft polymer layer (A2) may contain a constitutional unit derived from a reactive ultraviolet absorber. When the monomer mixture (a-2) contains a reactive ultraviolet absorber, an acrylic resin film having good weather resistance and chemical resistance can be easily obtained.

Any known reactive ultraviolet absorber can be used as the reactive ultraviolet absorber without any particular limitation. From the viewpoint of moldability and weather resistance of the acrylic resin film, the reactive ultraviolet absorber may be a compound represented by a general formula (1) below.

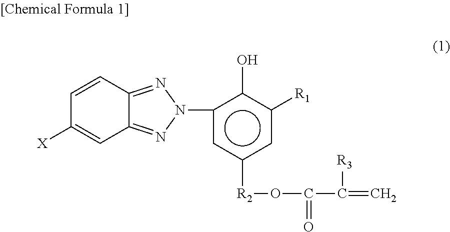

In the general formula (1), X represents a hydrogen atom or a halogen atom, R₁ represents a hydrogen atom, a methyl group, or a t-alkyl group having 4 to 6 carbon atoms, R₂ represents a linear or branched alkylene group having 2 to 10 carbon atoms, and R³ represents a hydrogen atom or a methyl group.

Specifically, examples of the reactive ultraviolet absorber represented by the general formula (1) include 2-(2′-hydroxy-5′-(meth)acryloyloxyethylphenyl)-2H-benzotriazoles, and more specifically 2-(2′-hydroxy-5′-acryloyloxyethylphenyl)-2H-benzotriazole, 2-(2′-hydroxy-5′-methacryloyloxyethylphenyl)-2H-benzotriazole, 2-(2′-hydroxy-5′-methacryloyloxyethylphenyl)-5-chloro-2H-benzotriazole, 2-(2′-hydroxy-5′-methacryloyloxypropylphenyl)-2H-benzotriazole, and 2-(2′-hydroxy-5′-methacryloyloxyethyl-3′-t-butylphenyl)-2H-benzotriazole. 2-(2′-hydroxy-5′-methacryloyloxyethylphenyl)-2H-benzotriazole may be used in terms of cost and handleability. In the present specification, (meth)acryloyl is a general term for acryloyl and methacryloyl.

The content of constitutional units derived from the reactive ultraviolet absorber in 100% by mass of the graft polymer layer (A2) may be 0.01% by mass to 5% by mass, or 0.1% by mass to 3% by mass.

The graft polymer layer (A2) may be obtained by graft copolymerizing, in at least one stage, in the presence of 5 to 90 parts by mass of the cross-linked elastomer particles (A1), 10 to 95 parts by mass of the monomer mixture (a-2) containing an methacrylic acid alkyl ester in an amount of 70% by mass to 99.5% by mass, an acrylic acid alkyl ester whose alkyl group has 2 or more carbon atoms in an amount of 0.5% by mass to 30% by mass, and the other vinyl-based monomer in an amount of 0% by mass to 19% by mass (where the total of the methacrylic acid alkyl ester, the acrylic acid alkyl ester, and the other vinyl-based monomer is 100% by mass). However, it is presumed that the total amount of the particles of the cross-linked elastomer (A1) and the monomer mixture (a-2) is 100 parts by mass.

In the manufacturing of the graft copolymer particles (A), particularly, in the graft copolymerization of the monomer mixture (a-2) in the presence of particles of cross-linked elastomer (A1), for example, acrylic acid ester-based cross-linked elastomer (A1), a polymer component (free polymer) that is not graft-bonded to the particles of the acrylic acid ester-based cross-linked elastomer (A1) may be produced. Such a free polymer can be used as a component constituting a part or the entirety of the acrylic resin that constitutes the acrylic resin composition and a matrix phase of the acrylic resin film.

A chain transfer agent may be added to the monomer mixture (a-2), for the purposes of controlling the molecular weight of the polymer, controlling the graft ratio to the cross-linked elastomer (A1) and the amount of free polymer produced that is not bonded to the cross-linked elastomer (A1), and controlling thermal stability and the like by reducing the double bond terminals of the polymer accompanying the disproportionation termination reaction during polymerization. Chain transfer agents that are similar to chain transfer agents that can be used in the polymerization of the cross-linked elastomer (A1) can be used as such chain transfer agents. The amount of the chain transfer agent used may be 0 to 2 parts by mass, or 0 to 0.5 parts by mass, with respect to 100 parts by mass of the total amount of the monomer mixture (a-2).

The graft ratio of the monomer mixture (a-2) to the particles of the cross-linked elastomer (A1), i.e., the graft ratio of the graft copolymer particles (A), may be 5% to 250%, 10% to 200%, or 20% to 150%. When the graft ratio is less than 5%, there is a tendency that the acrylic resin film has reduced resistance to whitening upon bending, reduced transparency, and reduced tensile elongation at break, making the acrylic resin film more susceptible to cracking during secondary molding. When the graft ratio exceeds 250%, there is a tendency that the melt viscosity of the acrylic resin composition increases during film formation, and the moldability of the acrylic resin film decreases. In the present specification, the graft ratio of the graft copolymer particles (A) can be calculated using the following formula by dissolving the powder of the graft copolymer particles (A) in methyl ethyl ketone, separating the resulting mixture into an insoluble portion and a soluble portion, and presuming the insoluble portion to be a graft portion.

Graft ratio (%)=100×(mass fraction of insoluble portion-mass fraction of cross-linked elastomer (A1))/mass fraction of cross-linked elastomer (A1)

An average particle size d (nm) of the acrylic acid ester-based cross-linked elastomer (A1) in the acrylic resin film and an amount w (% by mass) of a polyfunctional monomer used in the acrylic acid ester-based cross-linked elastomer (A1) may satisfy a relational formula: 0.015d≤w≤0.06d, or may satisfy a relational formula 0.02d≤w≤0.05d. When the amount of the polyfunctional monomer is in the range of the above relational formulas, the acrylic resin film has the following advantages: elongation during secondary molding of the acrylic resin film is unlikely to decrease, cracks are unlikely to form during molding or cutting, the acrylic resin film has excellent transparency, and stress whitening is unlikely to occur during bending or tension deformation at room temperature (about 25° C.), at a high temperature that is higher than or equal to a softening temperature of the acrylic resin film, or in a temperature range between room temperature and the Tg of the cross-linked elastomer (A1), and the acrylic resin film is unlikely to become cloudy or white due to moisture that permeates through the acrylic resin film through the contact between the acrylic resin film and moisture.

Like the graft copolymer particles (A), the graft copolymer particles (B) contain a cross-linked elastomer (B1), which is a rubber component. Like the graft copolymer particles (A), the graft copolymer particles (B) include a graft polymer layer (B2) located on the surface layer side relative to the cross-linked elastomer (B1). That is, the graft copolymer particles (B) may include a cross-linked elastomer (B1) for a core layer and a graft polymer layer (B2) for a shell layer. Also, both the core layer and the shell layer may have a multilayer structure.

The graft copolymer particles (B) are substantially similar to the graft copolymer particles (A) in terms of raw materials, a manufacturing method, and the like, except that the average particle size of the graft copolymer particles (B) is larger than that of the graft copolymer particles (A). Particles of the acrylic acid ester-based cross-linked elastomer (B1) may have a concentric spherical multilayer structure having a hard or semi-hard cross-linked resin layer inside the cross-linked elastomer layer. Examples of such hard or semi-hard cross-linked resin layers include hard cross-linked methacrylic resin particles as described in JP S55-27576A and the like, and cross-linked particles having a semi-hard layer made of a methyl methacrylate-acrylic acid ester-styrene copolymer as described in JP H4-270751A, WO 2014/41803, and the like. By introducing such a hard or semi-hard cross-linked resin layer, it is possible to improve the transparency, resistance to whitening upon bending, resistance to cracking upon bending, and the like of the graft copolymer particles (B) having a larger particle size than the graft copolymer particles (A).

The average particle size of the graft copolymer particles (B) may be 150 to 400 nm, or 200 to 350 nm. Compared to graft copolymer particles (A) having a smaller average particle size, graft copolymer particles (B) having a large average particle size more effectively induce plastic deformation (crazing) in the acrylic resin phase around the graft copolymer particles in response to the external force on the acrylic resin material. Therefore, the graft copolymer particles (B) are extremely effective in imparting impact resistance and crack resistance to the acrylic resin material. On the other hand, the graft copolymer particles (B) are inferior to the graft copolymer particles (A) in resistance to whitening upon bending and/or resistance to whitening due to solvents, and the like. Therefore, for example, by adding a small amount of the graft copolymer particles (B) to an acrylic resin composition containing an acrylic resin and graft copolymer particles (A), the following effects can be expected: (a) the surface hardness of the acrylic resin film and the laminate is not impaired by keeping the content of soft component in the acrylic resin film; (b) the stress whitening when external stress is applied to the acrylic resin film, blushing when coated the coating material containing an organic solvent and/or whitening under molding process tend to be suppressed; and (c) the crack resistance, secondary moldability, and the like of the acrylic resin film and the laminate are efficiently improved. Examples of acrylic resin films in which the graft copolymer particles (A) and a small amount of graft copolymer particles (B) are used in combination include those disclosed in WO 2013/051239, WO 2019/181752, and the like.

In the present specification, the average particle sizes of the graft copolymer particles (A) and the graft copolymer particles (B) are each an average particle size on a volume basis (also referred to as a mass basis), and can be measured in a latex state using a dynamic light scattering method by means of a laser diffraction/scattering particle size distribution measuring device such as Microtrac particle size analyzer MT3000 manufactured by Nikkiso Co., Ltd.

There is no particular limitation on a method for manufacturing the graft copolymer particles (A) and the graft copolymer particles (B), and known methods such as an emulsion polymerization method, a mini-emulsion polymerization method, a suspension polymerization method, and a solution polymerization method can be used. The emulsion polymerization method is particularly preferable because it allows a wide range of adjustment of the resin structure.

Known initiators such as organic peroxides, inorganic peroxides, and azo compounds can be used as an initiator used in emulsion polymerization of the graft copolymer particles (A) and/or the graft copolymer particles (B). Specifically, examples thereof include organic peroxides such as t-butyl hydroperoxide, 1,1,3,3-tetramethylbutyl hydroperoxide, cumene hydroperoxide, benzoyl peroxide, lauroyl peroxide, alkyl peroxycarbonates, and alkyl peroxy esters; inorganic peroxides such as potassium persulfate, sodium persulfate, and ammonium persulfate; and azo compounds such as azobisisobutyronitrile. These may be used alone or in combination of two or more.

These initiators may be used as (a) thermal decomposition type radical polymerization initiators, or (b) a redox type polymerization initiator system in which these initiators are combined with a catalyst such as ferrous sulfate and a reducing agent such as sodium sulfite, sodium thiosulfate, sodium formaldehyde sulfoxylate, ascorbic acid, and hydroxyacetone acid. Note that the catalyst may be used as a complex with ethylenediaminetetraacetic acid disodium or the like to ensure water solubility.

There is no particular limitation on the surfactant (also referred to as “emulsifier”) used in emulsion polymerization of the graft copolymer particles (A) and/or the graft copolymer particles (B). A wide variety of known surfactants can be used in emulsion polymerization. Examples of surfactants may include, for example, (a) anionic surfactants such as sodium salts, potassium salts, and ammonium salts of alkyl sulfonic acids, alkyl benzene sulfonic acids, dialkyl sulfosuccinic acids (such as dioctyl sulfosuccinic acid), alkyl sulfates, fatty acid sodium, polyoxyethylene alkyl ether acetates, polyoxyethylene alkyl ether phosphates, alkyl phosphates, alkyl ether phosphates, alkyl phenyl ether phosphates, surfactin, and the like, and (b) nonionic surfactants such as reaction products of alkyl phenols and propylene oxide and/or ethylene oxide, and reaction products of fatty alcohols and propylene oxide and/or ethylene oxide. These surfactants may be used alone or in combination of two or more.

The graft copolymer particles (A) or the graft copolymer particles (B) can be separated and collected using a known method from the latex of the graft copolymer particles (A) or the latex of the graft copolymer particles (B) obtained through emulsion polymerization. For example, a water-soluble electrolyte such as calcium chloride, magnesium sulfate, magnesium chloride, calcium acetate, sodium chloride, hydrochloric acid, acetic acid, or sulfuric acid is added to the latex to coagulate the graft copolymer particles, or the latex is frozen to separate the graft copolymer particles from an aqueous phase and coagulate them, and then, the graft copolymer particles (A) or the graft copolymer particles (B) can be separated and collected by filtering, washing, and drying the solid content. In addition, the graft copolymer particles (A) or the graft copolymer particles (B) can also be separated and collected by subjecting the latex to a treatment such as spray drying, cryocoagulation, or freeze drying.

For the purpose of reducing appearance defects and/or internal foreign matter in the acrylic resin film, prior to separation and collection of the graft copolymer particles (A) or the graft copolymer particles (B), the latex of the graft copolymer particles (A) or the latex of the graft copolymer particles (B) may be filtered through a filter and/or a mesh in advance to remove substances that may cause foreign matter defects, such as environmental foreign matter and polymerization scale.

Known filters and mesh materials used for filtering liquid media can be used as the filter and the mesh. The type of filter and mesh, the opening size, filtering accuracy, filtering capacity, and the like of the filter and the mesh are selected as appropriate depending on intended use and the type, size and amount of foreign matter to be removed. The opening size and the filtering accuracy of the filter and the mesh may be each, for example, at least twice as large as the average particle size of the graft copolymer particles (A) or the graft copolymer particles (B).

The content of the graft copolymer particles (A) in 100% by mass of the acrylic resin film is not particularly limited, and may be 10% by mass to 70% by mass, 15% by mass to 50% by mass, or 20% by mass to 45% by mass.

The content of the graft copolymer particles (B) in 100% by mass of the acrylic resin film is not particularly limited, and can be adjusted as appropriate within a range depending on application without impairing the quality of the laminate of one or more embodiments of the present invention, and from the viewpoint of suppressing stress whitening during stretching or bending process of the acrylic resin film and clouding of the film after the film comes into contact with moisture, the content may be 0% by mass to 20% by mass, 0% by mass to 10% by mass, or 0% by mass to 5% by mass. In addition, the acrylic resin film need not contain the graft copolymer particles (B).

### <Other Components>

The acrylic resin film (the acrylic resin composition that constitutes the acrylic resin film) may contain thermoplastic resin that is at least partially compatible with the acrylic resin as needed, within a range such that effects of one or more embodiments of the present invention are not hindered. Examples of such thermoplastic resins include styrene-based resins, polycarbonate resins, amorphous saturated polyester resins, olefin-methacrylic acid derivative resins, olefin-acrylic acid derivative resins, polyimide resins, polylactic acid resins, and PHBH (poly(3-hydroxybutyrate-co-3-hydroxyhexanoate)) resins. Examples of the styrene-based resins include styrene-acrylonitrile resins, styrene-(meth)acrylic acid resins, styrene-maleic anhydride resins, styrene-N-substituted maleimide resins, styrene-unsubstituted maleimide resins, styrene-acrylonitrile-butadiene resins, and styrene-acrylonitrile-acrylic acid ester resins. In particular, one or more thermoplastic resins selected from the group consisting of styrene-based resins, polycarbonate resins, and polyimide resins are preferable because they have excellent compatibility with acrylic resins and may be able to improve the resistance to cracking upon bending, solvent resistance, chemical resistance, low moisture absorption, and the like of the acrylic resin film. In the present specification, (meth)acrylic acid is a general term for acrylic acid and methacrylic acid.

The acrylic resin film (the acrylic resin composition that constitutes the acrylic resin film) may also contain a conventionally known additive used in the acrylic resin films as needed, within a range such that effects of one or more embodiments of the present invention are not hindered. Examples of such additives include antioxidants, ultraviolet absorbers, light stabilizers, light diffusing agents, matting agents, lubricants, colorants such as pigments and dyes, fibrous fillers, anti-blocking agents made of organic particles and/or inorganic particles, infrared reflectors made of metals and/or metal oxides, plasticizers, and antistatic agents. The additives are not limited to these. These additives can be used in any amount depending on the types of additives in a range such that effects of one or more embodiments of the present invention are not hindered or effects of one or more embodiments of the present invention are enhanced.

### <Physical Properties of Acrylic Resin Film>

A glass transition temperature (Tg) of the acrylic resin film may be 145° C. or lower, 140° C. or lower, 135° C. or lower, or 130° C. or lower. When the glass transition temperature of the acrylic resin film is 145° C. or lower, molding is possible without increasing the molding temperature, and there is an advantage that the formation of cracks during molding can be suppressed. In addition, there is no particular limitation on the lower limit of the glass transition temperature of the acrylic resin film, and from the viewpoint of preventing printing misalignment during drying of a print and improving reliability, the lower limit thereof may be, for example, 100° C. or higher. The glass transition temperature of the acrylic resin film can be determined using known methods such as differential scanning calorimetry (DSC).

A thickness of the acrylic resin film is not particularly limited, and may be, for example, 50 to 350 μm, 60 to 300 μm, or 70 to 250 μm. When the thickness of the acrylic resin film is within the above-described range, the film has sufficient stretchability and excellent handleability, and has the advantage that, when the acrylic resin film is laminated on a resin substrate (molded body substrate) in the production of a molded body, a good appearance can be obtained. In the present specification, the thickness of the acrylic resin film is measured using the method described in Examples.

The pencil hardness of the acrylic resin film measured according to JIS K 5600-5-4 may be 2B or more, B or more, or HB or more, under a load of 500 g, from the viewpoint of excellent surface hardness and scratch resistance.

### <Method for Manufacturing Acrylic Resin Film>

The acrylic resin film can be manufactured using known processing methods. Specific examples of known processing methods include a melt processing method, a calendering method, a press molding method, and a solvent casting method. Examples of the melt processing method include an inflation method and a T-die extrusion method. In addition, in the solvent casting method, for example, the acrylic resin composition is dissolved and dispersed in a solvent, and the resulting dispersion (dope) is cast on a belt-like substrate to form a film shape. Then, by volatilizing the solvent from the cast dope having film shape, an acrylic resin film can be obtained.

Among these methods, a solvent-free melt processing method is preferable, and a T-die extrusion method and a calendering method are particularly preferable. According to the melt processing method, there is little limitation on the thickness of the film to be manufactured, and films with excellent surface properties can be manufactured with high productivity, and the burden on a natural environment and a working environment due to the solvent can be reduced, and manufacturing costs can be reduced.

When the acrylic resin composition is molded into a film using a melt processing method or a solvent casting method, it is preferable to remove, through filtration using a filter or a mesh, environmental foreign matter, polymerization scale, degraded resin, and the like in the acrylic resin composition, which may cause defects in the appearance of the acrylic resin film, foreign matter within the acrylic resin film, and the like, from the viewpoint of improving the quality of the appearance of the acrylic resin film.

When a film is manufactured through melt processing, the acrylic resin composition can be filtered at any one or more of opportunity in the following process: when an acrylic resin composition is melt-kneaded after raw materials such as an acrylic resin and graft copolymer particles are blended; and during a melt film formation process using a T-die. In the solvent casting method, the acrylic resin composition could be filtered before cast to form a film after, the graft copolymer particles (A), the graft copolymer particles (B), and other components are mixed with a solvent.

Any known filters and meshes can be used as such filters and meshes without any particular limitations, as long as the filters and meshes have heat resistance and durability according to the melt processing conditions, or resistance to the solvent, dope, and the like used for casting.

When an acrylic resin film is manufactured through melt processing, in order to obtain a particularly high-quality acrylic resin film, it is preferable to use the filter that has a large filtering capacity and less retention of molten resin which causes occurrence of degraded and cross-linked that impair the quality of the film. For example, from the viewpoints of filtration efficiency and productivity, it is preferable to use a leaf disc type filter and a pleated filter.

When an acrylic resin film is manufactured using a T-die extrusion method, in order to improve the accuracy in the film thickness, for example, it is possible to use an automatic die device that measures online a film thickness distribution in the TD direction (direction perpendicular to the extrusion direction) of an extruded film and automatically adjusts a lip clearance of the T-die during extrusion of the film based on the measurement. The accuracy in the thickness of acrylic resin films can be improved by applying an automatic die using an appropriate control method.

In the manufacturing of acrylic resin films, as needed, when a film is to be molded, both sides of the molten film can be simultaneously brought into contact with (sandwiched between) cooling rolls or cooling belts to obtain a film with better surface properties. In this case, the molten film may be simultaneously brought into contact with cooling rolls or cooling belts maintained at a temperature that is higher than or equal to −80° C. of the glass transition temperature of the acrylic resin composition, or may be higher than or equal to −70° C. of the glass transition temperature. The upper limit of the temperature of the cooling roll or cooling belt is not particularly limited, and may be, for example, the glass transition temperature of the acrylic resin composition+10° C. or lower. At least one of the rolls for performing such sandwiching may be a roll having an elastic metal sleeve as disclosed in, for example, JP 2000-153547A, JP H11-235747A, and the like, and a low sandwiching pressure is applied to transfer a roll mirror surface or a specific surface shape. This makes it possible to obtain (a) a film with little residual strain and excellent smoothness, and/or (b) a film with an appropriate surface roughness, and having excellent slipperiness of the film surface, suppressed blocking between films, and less internal strain.

In addition, it is also possible to perform uniaxial stretching or biaxial stretching after film molding, depending on the purpose. Uniaxial stretching or biaxial stretching can be carried out using a known stretching machine. Biaxial stretching can be carried out in a known manner, such as sequential biaxial stretching or simultaneous biaxial stretching, a method in which longitudinal stretching is performed and lateral stretching is then carried out while relaxing the film in the longitudinal direction to suppress a bowing phenomenon of the film, or the like.

### (Substrate Layer)

The substrate layer includes an acrylic resin film. The substrate layer may have a smooth surface, or, depending on the application, within a range in which effects of one or more embodiments of the present invention are not hindered, one or both sides of the substrate layer may have any surface shape, such as hairlines, prisms, uneven shapes, three-dimensional decorations, a mat surface, a rough surface having certain surface roughness, and knurling on the film edges. Such a surface shape may be provided using a known method. For example, examples thereof include a method in which both surfaces (also referred to as both sides) of a film after extrusion or a molded film provided from an unwinding device are is sandwiched between two rolls or belts having a surface shape on at least one surface (also referred to as one side), and transferred the surface shape of the rolls. In addition, the substrate layer may be such that a printed decorative layer is laminated on one side or both sides of an acrylic resin film, depending on the application, in a range such that effects of one or more embodiments of the present invention are not hindered.

### (Cured Resin Layer)

The cured resin layer may be formed from a cured product of an active energy ray curable resin composition (hereinafter also simply referred to as “curable resin composition”) containing a urethane acrylate resin or a urethane acrylate resin, a hindered amine light stabilizer having a reactive functional group, and a compound having a hydrophobic group and a reactive functional group. Specifically, the cured resin layer can be formed by laminating a curable resin composition containing a urethane acrylate resin, or a curable resin composition containing a urethane acrylate resin, a hindered amine light stabilizer having a reactive functional group, and a compound having a hydrophobic group and a reactive functional group by applying the composition onto the substrate layer including the acrylic resin film and curing the curable resin composition. The cured resin layer may be formed on one side or both sides of the substrate layer including the acrylic resin film. From the viewpoint of not requiring a large-scale device such as a heater, being cured quickly, and being cost-effective, the curable resin composition for a cured resin layer may have active energy ray curability, and a urethane acrylate resin, a hindered amine light stabilizer having a reactive functional group, and a compound having a hydrophobic group and a reactive functional group may have active energy ray curability.

In the laminate according to one or more embodiments of the present invention, the cured resin layer is required to have high crack elongation as well as improved surface hardness. As a result, when the laminate is subjected to secondary molding to fit the shape of a molded body, breakage or severe whitening does not occur due to stretching process, bending process, or the like.

However, in general, in the cured resin layer, high surface hardness and scratch resistance are given by highly cross-linking curable resin composition and/or contains a filler with high hardness, for suppressing deformation of the surface of the cured product from an external stress. Therefore, surface hardness or scratch resistance, and deformability or stretchability, are mutually exclusive properties, and it has not been easy to accomplish the both properties in the cured resin layer at the same time.

In order to impart high stretchability during secondary molding while maintaining surface hardness of the cured resin layer, the curable resin (e.g., urethane acrylate resin) used in the cured resin layer can be designed using, for example, methods (1) to (3) below. In the cured resin layer, for example, any of the methods (1) to (3) and the like may be used alone or in combination as appropriate. Note that, for the cured resin layer, it is possible to use, as appropriate, a commercially available curable resin composition containing a urethane acrylate resin that can impart high stretchability during secondary molding while the surface hardness of the cured resin layer is maintained.

(1) The glass transition temperature of the cured curable resin composition is designed to be between room temperature and a secondary molding temperature (e.g., approximately 110° C. to 140° C.), and the curable resin is hard at room temperature, and softens and is deformable at the secondary molding temperature. As a result, the cured product of the curable resin (cured resin layer) exhibits high surface hardness at room temperature and exhibits favorable stretchability during secondary molding.

(2) By using a combination of a plurality of curable resins having different structures, the cross-linked structure of the cured curable resin is designed to be non-uniform in terms of microstructure, with comparatively hard portions having a high crosslink density and comparatively soft portions that have a low crosslink density and high plastic deformability, rather than being uniform. As a result, high surface hardness is achieved due to the portions having a high crosslink density in the cured product of the curable resin (cured resin layer), and at the time of secondary molding, the portions having a low crosslink density deform and exhibit favorable stretchability.

(3) The curable resin is blended with a resin component having a low degree of cross-linking or a non-cross-linked resin component, and/or a resin component having a low modulus of elasticity. As a result, after the curable resin is cured, a structure is formed in which fine regions (domains) having a low degree of cross-linking or non-cross-linked fine regions, and/or fine regions (domains) having a low modulus of elasticity are dispersed in a curable resin phase having a high crosslink density, thereby imparting deformability and stretchability to the cured product of the curable resin (cured resin layer) while maintaining a certain degree of surface hardness. Examples of such resin components having a low degree of cross-linking or non-cross-linked resin components, or resin components having a low modulus of elasticity include (a) thermoplastic resins such as thermoplastic methacrylic resins, styrene acrylonitrile resins, aliphatic polycarbonate resins, aromatic polycarbonate resins, polyester resins, phenoxy resins, cellulose acylate resins, fluororesins, and polyurethane resins; (b) cross-linked or non-cross-linked soft resins such as acrylic rubber, silicone rubber, hydrogenated styrene butadiene rubber, acrylonitrile butadiene rubber, olefin-based rubber, and urethane rubber, which may have a reactive functional group as needed, and thermoplastic elastomer materials such as polyester-based, polyurethane-based, acrylic, olefin-based, styrene-based, silicone-based, and fluororesin-based thermoplastic elastomer materials; and (c) core-shell rubber particles in which a thermoplastic resin is graft-polymerized onto the surface of cross-linked rubber particles.

### <Urethane Acrylate Resin>

The urethane acrylate resin can be obtained by, for example, mixing a polyhydric alcohol, a polyisocyanate, and a hydroxyl group-containing (meth)acrylate, and generating a urethane bond through reaction between the isocyanate group and the hydroxyl group. In the present specification, (meth)acrylate is a general term for acrylate and methacrylate.

Furthermore, a urethane acrylate resin can also be obtained by forming a (meth)acryloyl group at an end or at a side chain through a reaction between a hydroxyl group-containing (meth)acrylate and an isocyanate group at an end or at a side chain of a polyurethane compound obtained through a reaction between a polyhydric alcohol and a polyisocyanate. In the present specification, a (meth)acryloyl group encompasses a methacryloyl group and an acryloyl group.

Various properties of the urethane acrylate resin are not particularly limited, and the molecular weight, composition, a main chain structure such as a linear or branched chain, the number of functional groups, and the like can be adjusted as appropriate depending on the structure of the polyhydric alcohol, the type of polyisocyanate, the number of acryloyl groups or methacryloyl groups (CH₂═CH—CO— or CH₂═C(CH₃)—CO—) derived from the hydroxyl group-containing (meth)acrylate. Examples of the urethane acrylate resin further include resin compositions containing urethane acrylate resins that are commercially available as curable coating agents.

There is no particular limitation on the polyisocyanate, and it is sufficient that the polyisocyanate is a compound containing two or more isocyanate groups. Examples of polyisocyanate compounds include 2,4-tolylene diisocyanate, 2,6-tolylene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenylmethane diisocyanate, 4,4′-diphenylmethane diisocyanate, 4,4′-diphenylmethane triisocyanate, 3,3′-dimethylphenylene diisocyanate, 4,4′-biphenylene diisocyanate, 1,6-hexane diisocyanate, isophorone diisocyanate, methylene bis(4-cyclohexyl isocyanate), 2,2,4-trimethylhexamethylene diisocyanate, bis(2-isocyanate ethyl) fumarate, 6-isopropyl-1,3-phenyl diisocyanate, 4-diphenylpropane diisocyanate, tolidine diisocyanate, hydrogenated diphenylmethane diisocyanate, hydrogenated xylylene diisocyanate, tetramethylxylylene diisocyanate, 2,5-bis(isocyanate methyl)-bicyclo[2.2.1]heptane, 2,6-bis(isocyanate methyl) bicyclo[2.2.1]heptane, trimethylolpropane adducts of triethylene diisocyanate, isocyanurates of triethylene diisocyanate, oligomers of diphenylmethane-4,4′-diisocyanate, biurets of hexamethylene diisocyanate, isocyanurates of hexamethylene diisocyanate, uretdiones of hexamethylene diisocyanate, and isocyanurates of isophorone diisocyanate. In particular, polyisocyanate compounds that do not contain an aromatic structure and comprising a saturated aliphatic structure or an alicyclic structure are preferable because they provide a structure with superior weather resistance. Examples of such polyisocyanate compounds include 1,6-hexane diisocyanate, isophorone diisocyanate, methylene bis(4-cyclohexyl isocyanate), 2,2,4-trimethylhexamethylene diisocyanate, hydrogenated diphenylmethane diisocyanate, hydrogenated xylylene diisocyanate, 2,5-bis(isocyanatemethyl)-bicyclo[2.2.1]heptane, and 2,6-bis(isocyanatemethyl)-bicyclo[2.2.1]heptane. In addition, these polyisocyanates can be used alone or in combination of two or more.

Specific examples of polyhydric alcohols include ethylene glycol, 1,3-propanediol, 1,3-butanediol, 1,4-butanediol, 1,5-pentanediol, 1,6-hexanediol, 1,7-heptanediol, 1,8-octanediol, 1,9-nonanediol, 1,10-decanediol, 3-methyl-1,5-pentanediol, neopentyl glycol, 2-methyl-1,8-octanediol, cyclohexanediol, 1,4-cyclohexanedimethanol, glycerol, pentaerythritol, dipentaerythritol, polycaprolactone diol, polyethylene glycol, polypropylene glycol, polytetramethylene glycol, polyester diol, polycarbonate diol, polyurethane diol, bisphenol compounds, biphenol compounds, norbornadiol, dicyclopentanediol, and adamantanediol. In particular, polyhydric alcohols that do not contain an aromatic structure and comprising a saturated aliphatic structure or an alicyclic structure are preferable because they provide a structure with superior weather resistance. These polyhydric alcohols may be used alone or in combination of two or more.

The hydroxyl group-containing (meth)acrylate is not particularly limited, and for example, it is possible to add 2-hydroxyethyl acrylate and 2-hydroxyethyl methacrylate as well as (a) compounds having at least one hydroxyl group and an ethylenically unsaturated bond, such as 2-hydroxypropyl (meth)acrylate, 4-hydroxybutyl acrylate, polyethylene glycol mono(meth)acrylate, polypropylene glycol mono(meth)acrylate, trimethylpropane mono(meth)acrylate, trimethylolpropane di(meth)acrylate, allyl alcohol, ethylene glycol allyl ether, glycerin (mono-, di-)allyl ether, and N-methylol(meth)acrylamide, and like, or (b) mixtures thereof, as needed.

In order to promote the reaction between the isocyanate group and the hydroxyl group of the isocyanate component, an organotin-based urethanization catalyst may be used. It is sufficient that the organotin-based urethanization catalyst is any that is generally used in urethanization reactions, and examples thereof include dibutyltin dilaurate, dibutyltin diacetate, dibutyltin dialkyl malate, tin stearate, and tin octoate.

In one or more embodiments of the present invention, a commercially available curable resin composition containing a urethane acrylate resin may be used as at least a part of the curable resin composition for a cured resin layer. Examples of such commercially available products include product name “Z-607-27L” manufactured by Aica Kogyo Company, Limited, product name “BEAMSET 1200W” manufactured by Arakawa Chemical Industries, Ltd., product name “Acrit 8UX-116A” manufactured by Taisei Fine Chemical Co., Ltd., product name “NXD-004AP” manufactured by Nippon Kako Toryo Co., Ltd., product name “P-5820TAH-1” and “P-5820TA-20J” manufactured by Daido Chemical Corporation, and product name “Lioduras MOL7200” manufactured by Toyochem Co., Ltd. These commercially available curable resin compositions containing urethane acrylate resins have high elongation even after curing, and thus the crack elongation of a laminate at 120° C. can be further increased by using such products.

### <Light Stabilizer>

The curable resin composition for a cured resin layer may contain a light stabilizer. Since the curable resin composition for a cured resin layer contains a light stabilizer, the stability of the cured resin layer against degradation by ultraviolet light and visible light irradiation is improved, and weather deterioration of, such as surface cracking and peeling of the molded body covered with the laminate including the cured resin layer is suppressed at a locations or in the applications exposed to sunlight outdoors or indoors.

The curable resin composition for a cured resin layer may contain, as a light stabilizer, a hindered amine light stabilizer having at least a reactive functional group (also referred to as “reactive HALS” hereinafter). In the reactive HALS, the reactive functional group need to be reactive with the urethane acrylate resin, and examples thereof include a functional group having an ethylenic double bond. More specifically, the reactive functional group may include one or more selected from the group consisting of a methacryloyl group, an acryloyl group, a vinyl group, an allyl group, and the like, or may include one or more selected from the group consisting of a methacryloyl group and an acryloyl group. Since the hindered amine light stabilizer has a reactive functional group, when the urethane acrylate resin is to be cured, the hindered amine light stabilizer molecules react with the urethane acrylate resin and are introduced in a chemically bonded state into the cured product that forms the cured resin layer. This suppresses the hindered amine light stabilizer from migrating or bleeding out from the surface of the cured resin layer even in outdoor exposure environments and the like, and thus makes it possible to suppress deterioration of the weather resistance of the cured resin layer for a longer period of time.

Examples of reactive HALSs include, but are not limited to, 4-(meth)acryloyloxy-2,2,6,6,-tetramethylpiperidine, 4-(meth)acryloylamino-2,2,6,6-tetramethylpiperidine, 4-(meth)acryloyloxy-1,2,2,6,6-pentamethylpiperidine, 4-(meth)acryloylamino-1,2,2,6,6-pentamethylpiperidine, 4-cyano-4-(meth)acryloylamino-2,2,6,6-tetramethylpiperidine, 4-crotonoyloxy-2,2,6,6-tetramethylpiperidine, 4-crotonoylamino-2,2,6,6-tetramethylpiperidine, 1-(meth)acryloyl-4-(meth)acryloylamino-2,2,6,6-tetramethylpiperidine, 1-(meth)acryloyl-4-cyano-4-(meth)acryloylamino-2,2,6,6-tetramethylpiperidine, and 1-crotonoyl-4-crotonoyloxy-2,2,6,6-tetramethylpiperidine. These reactive HALSs may be used alone or in combination of two or more.

For example, commercially available products such as 1,2,2,6,6-pentamethyl-4-piperidinyl methacrylate (also known as 4-methacryloyloxy-2,2,6,6-tetramethylpiperidine, product name “ADK STAB LA-82” manufactured by ADEKA Corporation or product name “FA-711 MM” manufactured by Hitachi Chemical Co., Ltd.), 2,2,6,6-tetramethyl-piperidinyl methacrylate (also referred to as 4-methacryloyloxy-2,2,6,6-tetramethylpiperidine, product name “ADK STAB LA-87” manufactured by ADEKA Corporation, or product name “FA-712HM” manufactured by Hitachi Chemical Co., Ltd.) may be used as the reactive HALS.

The curable resin composition for a cured resin layer may contain the reactive HALS in an amount of 0.1 to 10 parts by mass, 0.5 to 6 parts by mass, or 1.0 to 4 parts by mass, with respect to 100 parts by mass of the urethane acrylate resin. The long-term weather resistance is improved due to the curable resin composition for a cured resin layer containing the reactive HALS in an amount of 0.1 parts by mass or more. In addition, when the amount of the reactive HALS is 10 parts by mass or less, weather resistance can be improved without impairing the quality of the cured resin layer.

The curable resin composition for a cured resin layer may contain, in addition to the reactive HALS, other light stabilizers such as hindered amine light stabilizers (also referred to as “HALS” hereinafter) that do not have a reactive functional group as needed. Examples of HALSs include bis(1,2,2,6,6-pentamethyl-4-piperidyl)sebacate, bis(1,2,2,6,6-pentamethyl-4-piperidinyl)sebacate, methyl(1,2,2,6,6-pentamethyl-4-piperidinyl)sebacate, and 2,4-bis[N-butyl-N-(1-cyclohexyloxy-2,2,6,6-tetramethylpiperidin-4-yl)amino]-6-(2-hydroxyethylamine)-1,3,5-triazine. In this case, from the viewpoint of further improving weather resistance without causing bleed out or curing inhibition during curing of the cured resin layer, the curable resin composition for a cured resin layer may contain the light stabilizers in a total amount of 0.5 to 10 parts by mass, 0.8 to 6 parts by mass, or 1.0 to 4 parts by mass, with respect to 100 parts by mass of the urethane acrylate resin.

<Compound having Hydrophobic Group and Reactive Functional Group>

The curable resin composition for a cured resin layer may contain a compound having a hydrophobic group and a reactive group (hereinafter also simply referred to as “hydrophobic reactive compound”). Such compounds are usually referred to as leveling agents, surfactants, antifouling agents, water repellents, oil repellents, dispersants, slip agents, and the like. Such compounds are selected and adjusted as appropriate in terms of composition, structure, etc., depending on the components of the substrate, curable resin, filler to be blended, and the like, and then blended into a curable resin composition and/or a coating material containing the curable resin composition. By blending these compounds into a curable resin composition and/or a coating material containing the curable resin composition, the molecules of these compound having hydrophobic groups and reactive groups will distribute at the surface or the interface with other materials such as the substrate or filler with locating their hydrophobic groups toward the surface or the interface after application of the curable resin composition and/or coating material, thereby reducing the surface tension of the curable resin composition and/or the coating material containing the curable resin composition and improving wettability with other materials. As a result, such compounds function to reduce the surface tension of the curable resin composition and/or the coating material containing the curable resin composition, and improve wettability with other materials. Furthermore, such compounds function to impart properties such as hydrophobicity, water repellency, oil repellency, antifouling properties, slipperiness, scratch resistance, and the like to the surface of the cured resin layer after application and/or after curing, smooth the surface of the cured resin layer after application and/or curing, and improve the dispersion state of components such as fillers that are blended in. In one or more embodiments of the present invention, it is presumed that, by adding a compound having a hydrophobic group and a reactive group to the curable resin composition for a cured resin layer, the surface of the cured resin layer is made hydrophobic, thereby more effectively inhibiting the permeation of the DEET material into the cured resin layer, and in particular, when the compound is used in combination with a reactive HALS, the compound has the effect of improving the weather resistance of DEET resistance.

### <Hydrophobic Group>

A hydrophobic reactive compound contains a hydrophobic group in the molecule. Specific examples of the hydrophobic group include a saturated hydrocarbon group, an aromatic hydrocarbon group, a silicone group, and a fluorine-containing group. Examples of the silicone group include alkyl-substituted polysiloxane groups such as a polydimethylsiloxane group, and some of the alkyl substituents may have functional groups other than a hydrocarbon group, and some or all of the hydrogen groups in the alkyl substituents may be substituted with fluorine groups. Examples of the fluorine-containing group include a partially fluorinated hydrocarbon group, a perfluoroalkyl group, a partially fluorinated polyalkyleneoxy group, polyperfluoroalkyleneoxy group, and a fluoroalkyl-substituted siloxane group. Among such hydrophobic groups, one or more selected from the group consisting of a silicone group and a fluorine-containing group are preferable, and a fluorine-containing group is more preferable, because it is presumed that these groups are highly hydrophobic, are excellent in the performance of imparting leveling properties and wettability through addition of the compound, are excellent in water repellency and oil repellency, and effectively improve DEET resistance. It is possible to use, as the hydrophobic group including a silicone group and a fluorine-containing group, a fluoroalkyl-substituted siloxane group as appropriate.

### <Reactive Group>

The hydrophobic reactive compound may have, in addition to the hydrophobic group, a reactive group in the molecule, or a functional group that can react with the urethane acrylate resin during the curing reaction. Since the hydrophobic reactive compound contains such a reactive group, a chemical bond is formed between the curable resin and the hydrophobic reactive compound (compound having a hydrophobic group and a reactive group) during the curing reaction, and thus the compound having the hydrophobic group and the reactive group is more likely to remain on the surface of the cured resin layer of the laminate without bleeding out from the surface of the cured resin layer, and it can be expected that functions such as hydrophobicity, water repellency, oil repellency, antifouling properties, slipperiness, scratch resistance, and DEET resistance will be maintained for a long period of time. Specific examples of such reactive groups include carbon-carbon double bond groups such as an acryloyl group, a methacryloyl group, a vinyl group, and an allyl group, and a thiol group. In particular, one or more selected from the group consisting of an acryloyl group and a methacryloyl group are preferable because they have favorable reactivity with a urethane acrylate group, and can maintain the weather resistance and the DEET resistance after a weathering test.

Commercially available products such as reactive leveling agents, antifouling agents, and surfactants may be used as the hydrophobic reactive compound. Specific examples thereof include, but are not limited to, commercially available products sold as leveling agents, surfactants, surface conditioners, or the like, such as the “BYK-UV” series (manufactured by BYK Chemie), the “MEGAFACE” series (manufactured by DIC Corporation), the “Ftergent” series (manufactured by Neos Company Limited), the KP series and the KY-1200 series (manufactured by Shin-Etsu Chemical Co., Ltd.), the “DISPARLON” series (manufactured by Kusumoto Chemicals, Ltd.), the “Polyflow” series (manufactured by Kyoeisha Chemical Co., Ltd.), and the “Surflon” series (manufactured by AGC Seimi Chemical Co., Ltd.). In particular, for example, “MEGAFACE RS” (manufactured by DIC Corporation), “Ftergent 601” (manufactured by Neos Company Limited), “KY-1203” (manufactured by Shin-Etsu Chemical Co., Ltd.), and the like are preferable because it is expected that a relatively high water contact angle and a relatively high oleic acid contact angle can be imparted to the surface of the cured resin layer, and DEET resistance, in particular, DEET resistance after the weathering test, and the like can be improved.

The curable resin composition for a cured resin layer may contain the compound having a hydrophobic group and a reactive group in an amount of 0.01 to 5 parts by mass, 0.05 to 4 parts by mass, or 0.1 to 3 parts by mass, with respect to 100 parts by mass of the urethane acrylate resin. When the curable resin composition contains the compound having a hydrophobic group and a reactive group in an amount of 0.01 parts by mass or more, leveling properties of the curable resin composition for a cured resin layer are improved, the wettability to the substrate and the filler component is improved, and defects such as cissing are prevented, and the weather resistance of the DEET resistance is also improved due to the reactive HALS being used in combination. Furthermore, when the amount of the compound having the hydrophobic group and the reactive group is 5 parts by mass or less, adverse effects such as a decrease in substrate adhesion and a decrease in recoatability due to excessive addition thereof are unlikely to occur.

### <Other Components>

The curable resin composition for a cured resin layer may contain other components, in addition to the above-described components. As other components, for example, monomers, oligomers, and resins that have a radical reactive functional group, such as (meth)acrylate-based compounds, epoxy acrylate-based monomers, polyester acrylates, and polyacryl acrylates, or mixtures thereof may be used in combination. Further, the urethane acrylate resin may be used in combination with, for example, (a) a hydrolysis condensate of a di- to tetra-functional silane compound, and/or (b) a monomer, an oligomer, and a resin that have cationically curable and/or anionically curable functional groups such as an epoxy group and an oxetane group, or a composition containing a mixture thereof. These other components may be used alone or in combination of two or more.

There is no particular limitation on the (meth)acrylate-based compound, as long as it has at least one or more (meth)acryloyl groups. Specific examples thereof include monofunctional (meth)acrylates such as alkyl (meth)acrylates, aryl (meth)acrylates, phenoxyethyl (meth)acrylates, and isobornyl (meth)acrylates; and polyfunctional (meth)acrylates such as polyalkylene glycol di(meth)acrylates, dipentaerythritol hexa(meth)acrylates, dipentaerythritol penta(meth)acrylates, dipentaerythritol tetra(meth)acrylates, dipentaerythritol tri(meth)acrylates, pentaerythritol tetra(meth)acrylates, pentaerythritol tri(meth)acrylates, trimethylolpropane tri(meth)acrylates, trimethylolethane tri(meth)acrylates, hexanediol di(meth)acrylates, and diethylene glycol di(meth)acrylates. These may be used alone or in combination of two or more. Examples of (meth)acrylate-based compounds include (meth)acrylate-based compounds that are commercially available as ultraviolet-curable hard coating agents.

There is no particular limitation on the epoxy acrylate-based monomers. Specifically, examples thereof include glycidyl (meth)acrylate, β-methylglycidyl (meth)acrylate, 3,4-epoxycyclohexylmethyl (meth)acrylate, and vinylcyclohexene monoxide (i.e., 1,2-epoxy-4-vinylcyclohexane). Also, so-called vinyl ester monomers obtained through a reaction between acrylic acid and the epoxy group of an epoxy resin monomer having a skeleton such as a bisphenol, novolac, or biphenyl skeleton can also be used as epoxy acrylate-based monomers.

A known method can be applied as a method for curing a resin layer (coating film of the curable resin composition) when a cured resin layer is formed. A method for irradiating the resin layer with active energy rays represented by ultraviolet rays or electron beam rays is preferable as a curing method. When the resin layer is cured by irradiation with ultraviolet rays, a photopolymerization initiator is used.

Specific examples of the photopolymerization initiator include acetophenone, benzophenone, benzoyl methyl ether, benzoyl ethyl ether, benzoin isopropyl ether, benzoin isobutyl ether, dibenzyl, 1-hydroxy-cyclohexyl-phenyl-ketone, 2,2-dimethoxy-2-phenylacetophenone, tetramethylthiuram monosulfide, tetramethylthiuram disulfide, thioxanthone, 2-chlorothioxanthone, 2-methylthioxanthone, and 2-methyl-1-[4-(methylthio)phenyl]-2-morpholinopropan-1-one. In particular, 1-hydroxy-cyclohexyl-phenyl-ketone that is high compatibility with a urethane acrylate resin is preferable.

The cured resin layer can be formed by applying a curable resin composition to one or both sides of a substrate layer including the acrylic resin film and curing a resin layer (coating film) made of the curable resin composition.

When the cured resin layer is formed by applying the curable resin composition for a cured resin layer to one or both sides of a substrate layer including the acrylic resin film and curing the resulting coating film, it is possible to add, to the curable resin composition, as needed, various additives such as an ultraviolet absorber, an antifoaming agent, an antioxidant, a light diffusing agent, a matting agent, a lubricant, colorants such as pigments and dyes, organic particles, inorganic particles, and antistatic agents. The additives are not limited to these.

In addition, from the viewpoint of surface hardness and wear resistance, inorganic fine particles may be added to the curable resin composition for a cured resin layer in a range such that effects of one or more embodiments of the present invention are not hindered. There is no particular limitation on the inorganic fine particles, and examples thereof include silica, alumina (aluminum oxide), titanium oxide, zinc oxide, zirconia, graphene, nanocarbon, carbon black, nanodiamond, mica, barium titanate, boron nitride, metallic silver, and metallic copper. These inorganic fine particles may be used without performing surface treatment, or may be surface-treated in advance using a known method in order to control a dispersion state and maintain favorable stretchability, and the affinity with the cured resin layer may be controlled as appropriate.

In addition, from the viewpoint of enhancing an antiglare property of the laminate, the curable resin composition for a cured resin layer may contain antiglare particles in a range such that effects of one or more embodiments of the present invention are not hindered. With regard to antiglare particles, for example, in order to obtain a balance of various properties such as a desired antiglare property, clarity of a transmitted image, glare, jet black surface, surface hardness, slipperiness, and an antistatic property, the particle material, the amount of particles, the type of particle dispersion solvent, a particle size, a dispersed particle size, the thickness of a cured resin layer, a difference in refractive index with respect to the substrate layer including an acrylic resin film, the affinity and reactivity of the particle surface with the substrate layer including an acrylic resin film or the solvent, and the like can be adjusted as appropriate within known technical ranges in which effects of one or more embodiments of the present invention are not hindered.

The material of antiglare particles to be blended in the cured resin layer is not particularly limited as long as the antiglare property of the laminate can be enhanced in a range such that effects of one or more embodiments of the present invention are not hindered, and for example, inorganic particles and/or organic particles can be used. Examples of inorganic particles include silica, alumina, glass beads, glass flakes, mica, clay, titanium oxide, zinc oxide, zirconia, and metal particles. Examples of organic particles include cross-linked organic resin particles having one or more main components selected from the group consisting of alkyl (meth)acrylate units, aromatic vinyl units, and siloxane units, and core-shell resin particles having a multilayer structure. From the viewpoint of ease of availability and ease of designing an antiglare property according to applications, particles may be one or more selected from the group consisting of inorganic oxide particles (e.g., silica, alumina, titanium oxide, zinc oxide, zirconia, and the like) and cross-linked organic resin particles (e.g., cross-linked silicone resin, cross-linked acrylic resin, cross-linked aromatic vinyl resin, and the like), or one or more selected from the group consisting of silica, alumina, zirconia, and cross-linked organic resin particles. In addition, from the viewpoint of the balance of physical properties such as an antiglare property, dispersibility, and surface hardness, the particles may be one or more selected from the group consisting of silica, alumina, and cross-linked organic resin particles. Also, from the viewpoint of controlling dispersibility, these particles may be subjected to surface treatment and/or graft polymerization treatment, or the like, using a known method such as the use of a silane coupling agent or reactive monomer that may have a reactive substituent, plasma treatment, corona treatment, or the like. At least some of the particles may have reactive functional groups that are reactive with the urethane acrylate resin on surfaces of the particles, because interfacial adhesion between the particles and the cured resin layer is improved, and the dispersibility of the particles, and the cracking and/or whitening during stretching can be improved. Examples of reactive functional groups that are reactive with the urethane acrylate resin include (a) radically reactive functional groups such as a vinyl group and a (meth)acryloyl group, (b) ionic functional groups such as an epoxy group, an oxetane group, a hydroxyl group, a carboxyl group, a mercapto group, an isocyanyl group, a hydroxyl group, and an amino group, and (c) moisture-curable functional groups such as a silyl group and an alkoxysilyl group.

In the cured resin layer, “antiglare particles” or “inorganic fine particles” may be dispersed in the state of primary particles, or may be dispersed in a state where a plurality of particles are aggregated, depending on the size of the primary particles. The size of regions (dispersed domains) in which these particles or fine particles, or their aggregates are distributed is defined as an “average dispersed particle size”. When the primary particle size is large, the average dispersed particle size may be the same as the primary (basic) particle size.

The average dispersed particle size of the antiglare particles is not particularly limited as long as effects of one or more embodiments of the present invention are obtained, and may be, for example, 0.1 to 50.0 μm, 0.2 to 25.0 μm, or 0.5 to 10 μm, or the like. In the present specification, a photograph of a cross section of the laminate with a size of 1200 nm×800 nm is observed using an electron microscope (H7650 manufactured by Hitachi High-Tech Corporation) at a magnification of 200,000, and an arithmetic mean value of the particle sizes of 10 dispersed domains of the antiglare particles in the cured resin layer is calculated, and the obtained value is regarded as the average dispersed particle size of the antiglare particles in the cured resin layer.

The average dispersed particle size of the inorganic fine particles is not particularly limited as long as effects of one or more embodiments of the present invention are obtained, and may be, for example, 0.5 to 1000 nm, 1 to 500 nm, or 2 to 200 nm, or the like. In the present specification, a photograph of a cross section of the laminate with a size of 1200 nm×800 nm is observed using an electron microscope (H7650 manufactured by Hitachi High-Tech Corporation) at a magnification of 200,000, and an arithmetic mean value of the particle sizes of 10 dispersed domains of the inorganic fine particles in the cured resin layer is calculated, and the obtained value is regarded as the average dispersed particle size of the inorganic fine particles in the cured resin layer.

The content of the antiglare particles in the curable resin composition for a cured resin layer is not particularly limited as long as the antiglare property of the laminate can be enhanced in a range such that effects of one or more embodiments of the present invention are not hindered, and for example, the content of the particles may be, for example, 0.1% by mass to 30.0% by mass, 0.5% by mass to 20.0% by mass, or 1.0% by mass to 15.0% by mass, or the like.

The content of the inorganic fine particles in the curable resin composition for a cured resin layer is not particularly limited as long as the wear resistance of the laminate can be enhanced in a range such that effects of one or more embodiments of the present invention are not hindered, and for example, the content of the inorganic fine particles may be, for example, 0.1% by mass to 30.0% by mass, 0.3% by mass to 20.0% by mass, or 0.5% by mass to 15.0% by mass, or the like.

In order to impart appropriate coatability to the curable resin composition for a cured resin layer, an organic solvent is usually blended therein. The organic solvent is not particularly limited as long as desired coatability can be imparted to the curable resin composition, and a cured resin layer having desired thickness and performance can be formed. The boiling point of the organic solvent may be 50° C. to 150° C. in terms of coatability and a drying property of the resin layer (coating film) to be formed.

Specific examples of the organic solvents include saturated hydrocarbons such as hexane; aromatic hydrocarbons such as toluene and xylene; halogenated hydrocarbons such as chloroform and methylene chloride; alcohols such as methanol, ethanol, isopropyl alcohol, and butanol; esters such as methyl acetate, ethyl acetate, and butyl acetate; ketones such as acetone, methyl ethyl ketone, methyl isobutyl ketone, and cyclohexanone; ethers such as tetrahydrofuran, dioxane, propylene glycol monoethyl ether, methyl cellosolve, and ethyl cellosolve; and amides such as N-methylpyrrolidone and dimethylformamide. These organic solvents can be used alone or in combination of two or more.

When the curable resin composition for a cured resin layer is applied to one or both sides of the substrate layer including an acrylic resin film, any method can be used as a coating method without any particular limitation. Examples of the coating method include reverse coating, gravure coating, bar coating, die coating, spray coating, kiss coating, wire bar coating, and curtain coating. These coating methods may be used alone or in combination of two or more.

The above-described curable resin composition for a cured resin layer is applied to one or both sides of a substrate layer including an acrylic resin film to form a resin layer (coating film), and then the organic solvent is removed from the coating film through drying, and the resin layer is cured by active energy rays, such as ultraviolet irradiation, thereby forming a cured resin layer.

The drying temperature for removing the organic solvent from the resin layer after coating may be 60° C. to 120° C., or 70° C. to 100° C. If the drying temperature is excessively low, the organic solvent may remain in the resin layer (coating film). In addition, if the drying temperature is excessively high, the flatness of the laminate (cured resin layer) may be impaired due to thermal deformation of the acrylic resin film.

The wavelength of the ultraviolet rays used for irradiation when the resin layer (coating film) is cured may be in a range of 200 to 400 nm. The integrated light quantity of the ultraviolet (UV) irradiation may be, for example, 500 mJ/cm² or more, 550 mJ/cm² or more, or 600 mJ/cm² or more. By setting the integrated light quantity of the UV irradiation to 500 mJ/cm² or more, the degree of curing of the cured resin layer can be increased, specifically, the cure index represented by the formula 1 described above can be lowered and/or the degree of curing represented by the formula 2 below can be increased, thereby increasing the crosslink density of the cured resin layer and increasing the hardness, DEET resistance, and the weather resistance of the DEET resistance (DEET resistance after weathering test) of the laminate. The upper limit of the integrated light quantity may be set as appropriate in consideration of energy efficiency as well as prevention of deterioration of the cured resin layer caused by excessive ultraviolet irradiation and the resulting heat generation or the like. For example, the upper limit thereof may be 1500 mJ/cm² or less, and may be 1400 mJ/cm² or less, 1300 mJ/cm² or less, 1200 mJ/cm² or less, 1100 mJ/cm² or less, 1000 mJ/cm² or less, 900 mJ/cm² or less, or 800 mJ/cm² or less.

### < “Cure Index” and “Degree of Curing”>

In the laminate of one or more embodiments of the present invention, the cured resin layer needs to have a cure index of 0.013 or less as described above. The degree of curing of the cured resin layer represented by a formula 2 below may be 75% or more.

In general, in the cross-linking reaction of the curable resin composition, the higher the degree of cross-linking, the more the movement of the cross-linked polymer chains is restricted. Therefore, it is rare for the curing reaction to progress by 100%, and unreacted curable functional groups often remain. The degree of progress of the curing reaction is usually quantified by quantifying the spectra corresponding to the functional groups before and after the reaction using analytical techniques such as CP/MAS (Cross Polarization Magic Angle Spinning)-1H NMR. However, in the present specification, the degree of progress of the curing reaction of a cured resin layer formed from a cured product of the active energy ray curable resin composition containing a urethane acrylate resin can be expressed as a cure index calculated by the formula 1 and/or the degree of curing calculated by the formula 2 below, using FT-IR analysis in reflection mode.

$$Cure index = B / D \qquad [ Formula 1 ]$$

$$Degree of curing ( \% ) = 100 \times [ ( A / C ) - ( B / D ) ] / ( A / C ) \qquad [ Formula 2 ]$$

Note that, in the formulas 1 and 2 above, A represents the area of the infrared absorption peak at a wavenumber of about 810 cm⁻¹ in FT-IR measurement of the coating film of the active energy ray curable resin composition before curing, B represents the area of the infrared absorption peak at a wavenumber of about 810 cm⁻¹ in FT-IR measurement of the cured resin layer, C represents the area of the infrared absorption peak at a wavenumber of about 1705 cm⁻¹ in FT-IR measurement of the coating film of the active energy ray curable resin composition before curing, and D represents the area of the infrared absorption peak at a wavenumber of about 1705 cm⁻¹ in FT-IR measurement of the cured resin layer.

The peak at a wavenumber of about 810 cm⁻¹ in the infrared spectrum corresponds to out-of-plane bending vibration of the C—C double bonds of the acryloyl group and the methacryloyl group. A reflects the content of the acryloyl and methacryloyl groups in the coating film of the active energy ray curable resin composition before curing, and B reflects the content of the acryloyl and methacryloyl groups in the cured resin layer, i.e., the coating film of the active energy ray curable resin composition after curing. The values of A and B decrease as the curing reaction progresses. The infrared absorption peak at a wavenumber of about 1705 cm⁻¹ in the FT-IR measurement corresponds to stretching vibration of the C—O double bond of the ester group. C and D reflect the total amount of uncured acryloyl and methacryloyl groups, as well as the ester groups after the acryloyl and methacryloyl groups have undergone a curing reaction, in the coating film of the active energy ray curable resin composition before and after the curing reaction, respectively, and in principle, the total amount of C—O double bond functional groups does not change before and after the curing reaction. Therefore, the aforementioned cure index B/D is obtained by dividing the peak area value corresponding to the acryloyl group and the methacryloyl group, which are functional groups that decrease in number through the curing reaction, by the peak area value that does not change in principle through the reaction. The cure index reaches a maximum in the unreacted state and becomes 0 when the curing reaction progresses completely, and can be used as an index of the progress of the curing reaction. Furthermore, the degree of curing represented by the formula 2 indicates a ratio of the amount of acryloyl groups and methacryloyl groups remaining after curing to the amount of acryloyl groups and methacryloyl groups before curing, and can be used as an index of the progress of the curing reaction.

Furthermore, for the purpose of further improving the surface hardness, DEET resistance, weather resistance, and the like of a molded body having a laminate of one or more embodiments of the present invention placed on its surface, an operation for irradiating the molded body with active energy rays such as ultraviolet rays may be performed after secondary molding through vacuum and/or pressure molding of the laminate, or the operation may be performed on at least a portion of the molded body having the laminate placed on its surface.

### (Laminate)

In one or more embodiments of the present invention, a laminate may include a substrate layer including an acrylic resin film and a cured resin layer laminated on one side of the substrate layer. Further, in the laminate, the cured resin layer may be laminated on both sides of the substrate layer. In addition, the laminate may include another functional layer laminated between the substrate layer and the cured resin layer and/or on one side or both sides of the laminate, as needed, in a range such that effects of one or more embodiments of the present invention are not hindered.

There is no particular limitation on the other functional layer, and a wide variety of conventionally known layers can be used. Examples of the other functional layer include a printing layer, a decorative layer, an adhesive layer, an antistatic layer, a conductive layer, a dielectric layer, a thermoplastic resin layer, and an optically functional layer. The decorative layer may include a colored layer, a design layer, a surface uneven layer, and an embossed layer. The adhesive layer may include a primer layer or the like. Examples of the thermoplastic resin layer include an antifouling layer, an anti-fingerprint layer, a hard coat layer, a scratch-resistant layer, a gas barrier layer, and a gas absorbing layer. Examples of the optical functional layer include a low refractive index layer, a high refractive index layer, an ultraviolet shielding layer, an infrared shielding layer (also referred to as a “reflective layer”), a light diffusing layer, an antiglare layer, a matting layer, a phase difference adjusting layer, a viewing angle adjusting layer, and a polarizing layer. The laminate may also include two or more other functional layers used in combination. Further, one functional layer may have two or more functions.

The laminate has a crack elongation of 80% or more at 120° C. This makes it possible to suppress the occurrence of defects such as cracks and whitening in the laminate, when the laminate is laminated on a molded body substrate such as a thermoplastic resin substrate and the molded body substrate such as the thermoplastic resin substrate is covered with the laminate, particularly when the laminate is shaped through vacuum molding under heating or compressed air molding, or laminated and molded onto a substrate, or when, as needed, the shaped laminate is placed on the surface of a mold and then a molded body is obtained through insert injection molding, thereby providing good secondary moldability. The laminate may have a crack elongation of 90% or more at 120° C. There is no particular limitation on the upper limit of the crack elongation at 120° C. of the laminate. In the present specification, the crack elongation of the laminate at 120° C. can be measured using the method described in Examples.

From the viewpoint of suppressing whitening during molding, the laminate may have a haze change (Δhaze) of 0.5% or less, 0.3% or less, or 0.2% or less, when the laminate is stretched by 40% at 120° C. From the viewpoint of suppressing whitening during molding, the laminate may have a haze change (Δhaze) of 0.5% or less, 0.3% or less, or 0.2% or less, when the laminate is stretched by 80% at 120° C. In the present specification, the Δhaze of the laminate stretched by 40% at 120° C. and the Δhaze of the laminate stretched by 80% at 120° C. can be measured using the method described in Examples. In this specification, the wording “stretched by 40%” means that, when the size of the laminate before stretching is L1 and the size after stretching is L2, [100×(L2−L1)/L1]% is 40%, and the wording “stretched by 80%” means that, when the size before stretching is L1 and the size after stretching is L2, [100×(L2−L1)/L1]% is 80%.

From the viewpoint of excellent surface hardness and enhancing the scratch resistance of a molded body obtained using the laminate, the pencil hardness of the laminate on the cured resin layer side under a load of 500 g may be B or more, HB or more, F or more, or H or more.

From the viewpoint of excellent chemical resistance, the appearance of the laminate may have no visible change when about 0.02 mL of isopropyl alcohol is dropped onto the surface of the cured resin layer and is left at 23° C. for 6 hours. In addition, from the viewpoint of excellent chemical resistance, the appearance of the laminate may have no visible change when about 0.02 mL of acetone is dropped onto the surface of the cured resin layer and is left at 23° C. for 6 hours.

From the viewpoint of excellent wear resistance, the laminate may have a haze change (Δhaze) of 0.5% or less, 0.4% or less, or 0.3% or less, before and after a wear resistance test in which gauze is moved back and forth 20 times against the surface of the cured resin layer under a load of 500 g/cm².

From the viewpoint of excellent wear resistance, the laminate may have a haze change (Δhaze) of 2% or less, 1.8% or less, or 1.6% or less, before and after the wear resistance test in which steel wool (#0000) is moved back and forth 10 times against the surface of the cured resin layer under a load of 100 g/cm².

It is desired that the laminate shows no change in appearance when the DEET resistance is evaluated under the following conditions. That is, it is preferable that the appearance has no visible change after gauze coated with 0.05 g of an insect repellent containing a 30% ethanol solution of N,N-diethyl-3-methylbenzamide is placed on the surface of the cured resin layer of the laminate and the laminate is left for 30 seconds under conditions of 23° C. and a relative humidity of 65%, and then left standing in a thermostatic chamber at 74° C. for 1 hour.

It is desirable for the laminate to retain its DEET resistance, i.e., have weather resistance in terms of the DEET resistance after the weathering test corresponding to the level of weather resistance required, for example, in some automobile interior applications. That is, the appearance of the laminate may have no visible change when a weathering test in which the laminate is placed such that the cured resin layer side is located on the light source side, and a xenon lamp is used as a light source is performed for 300 hours under conditions of irradiance of 180 W/m² (300 to 400 nm) with a black panel temperature of 89° C. and no rain, and gauze coated with 0.05 g of an insect repellent containing a 30% ethanol solution of N,N-diethyl-3-methylbenzamide is then placed on a surface of the cured resin layer of the laminate, the laminate is left for 30 seconds under conditions of 23° C. and a relative humidity of 65%, and the laminate is left standing for 1 hour in a thermostatic chamber at 74° C. The appearance of the laminate may have no visible change when a weathering test in which the laminate is placed such that the cured resin layer side is located on the light source side, and a xenon lamp is used as a light source is performed for 500 hours under conditions of irradiance of 180 W/m² (300 to 400 nm) with a black panel temperature of 89° C. and no rain, and gauze coated with 0.05 g of an insect repellent containing a 30% ethanol solution of N,N-diethyl-3-methylbenzamide is then placed on a surface of the cured resin layer of the laminate, the laminate is left for 30 seconds under conditions of 23° C. and a relative humidity of 65%, and the laminate is then left standing for 1 hour in a thermostatic chamber at 74° C.

From the viewpoint of weather resistance, a color difference ΔE of the laminate after the above weathering test performed for 300 hours or 500 hours relative to the laminate before the weathering test may be 0.5 or less, or 0.3 or less.

From the viewpoint of weather resistance, ΔYI of the laminate after the above weathering test performed for 300 hours or 500 hours relative to the laminate before the weathering test may be 0.5 or less, or 0.3 or less. In the present specification, ΔYI can be measured and calculated using the methods described in Examples.

From the viewpoint of DEET resistance, the laminate may have a water contact angle of 105° or more on the surface of the cured resin layer. Further, from the viewpoint of weather resistance of the DEET resistance, the laminate may have a water contact angle of 95° or more on the surface of the cured resin layer after the above weathering test performed for 300 hours. Further, from the viewpoint of weather resistance of the DEET resistance, the laminate may have a water contact angle of 92° or more on the surface of the cured resin layer after the above weathering test performed for 500 hours. In the present specification, the water contact angle can be measured using the method described in Examples.

From the viewpoint of DEET resistance, the laminate may have an oleic acid contact angle of 65° or more on the surface of the cured resin layer. The oleic acid contact angle on the surface of the laminate on the cured resin layer side can be measured using the method described in Examples.

From the viewpoint of transparency, the haze of the laminate may be 2.0% or less, 1.5% or less, 1.0% or less, 0.8% or less, 0.6% or less, or 0.4% or less. From the viewpoint of weather resistance of transparency, the haze of the laminate after the weathering test performed for 300 hours may be 2.0% or less, 1.5% or less, 1.0% or less, 0.8% or less, or 0.6% or less. From the viewpoint of weather resistance of transparency, the haze of the laminate after the weathering test performed for 500 hours may be 2.0% or less, 1.5% or less, 1.0% or less, 0.8% or less, or 0.6% or less. However, this does not necessarily apply when components such as a matting agent and an antiglare agent are introduced into an acrylic resin film substrate and/or a cured resin layer based on the quality requirements such as appearance. In the present specification, the haze can be measured using the method described in Examples.

From the viewpoint of transparency, the total light transmittance of the laminate may be 90% or more, or 91% or more. From the viewpoint of weather resistance of transparency, the total light transmittance of the laminate after the above weathering test performed for 300 hours may be 90% or more, or 91% or more. From the viewpoint of weather resistance of transparency, the total light transmittance of the laminate after the above weathering test performed for 500 hours may be 90% or more, or 91% or more. In the present specification, the total light transmittance can be measured using the method described in Examples.

The laminate can be used as a decorative protecting sheet for decorating and/or protecting a molded body. When the laminate is used as a decorative protecting sheet, the laminate may further include, in addition to the substrate layer and the cured resin layer, one or more layers selected from the group consisting of the above-described printing layer, decorative layer, adhesive layer, antistatic layer, thermoplastic resin layer, and optically functional layer. By using the laminate as a decorative protecting sheet, it is possible to impart various functionalities to the molded body, such as DEET resistance, weather resistance, scratch resistance, and DEET resistance after the weathering test.

### (Molded Body)

In one or more embodiments of the present invention, the molded body includes the laminate, and the laminate is laminated on a surface of the molded body substrate, and a cured resin layer of the laminate is located on a surface side of the molded body relative to the substrate layer of the laminate. The laminate may be laminated on a portion or the entirety of the surface of the molded body substrate. Since the laminate has a high crack elongation at 120° C., it is possible to suitably obtain a molded body, and more specifically, a resin molded body having a three-dimensional shape by covering, with the laminate, a molded body substrate having at least a portion having a non-planar three-dimensional shape. In molded bodies having various shapes, the laminate covers the molded body substrate and thus can provide various functionalities such as DEET resistance, weather resistance, scratch resistance, and DEET resistance after the weathering test to the molded bodies.

The molded body substrate is not particularly limited, and a thermoplastic resin substrate can be suitably used. The thermoplastic resin substrate may be constituted by, for example, a polycarbonate resin having a bisphenol-based skeleton, a fluorene-based skeleton, or an isosorbide-based skeleton, an acrylic resin, a styrene-based resin (such as AS resin, ABS resin, MAS resin, styrene-maleimide-based resin, and styrene-maleic anhydride resin), a saturated polyester resin, a polyvinyl chloride, a polyarylate resin, a PPS-based resin, a POM-based resin, a polyamide resin, a polylactic resin, a cellulose acrylate-based resin, a polyolefin-based resin, or the like. In particular, one or more resins selected from the group consisting of polycarbonate resins, acrylic resins, styrene-based resins, and amorphous polyolefin-based resins are preferable because these resins have excellent transparency, and polycarbonate resins and/or acrylic resins are more preferable because these resins have good adhesion to the laminate, and polycarbonate resins are even more preferable from the viewpoint of high rigidity, high heat resistance, and high impact resistance.

The molded body has excellent weather resistance, scratch resistance, DEET resistance, and DEET resistance before and after the weathering test, and can be used as, for example, vehicle interior members such as automobile interior members, vehicle exterior members such as automobile exterior members, housing and exterior members for portable electronic devices and personal computers, and exterior members for home appliances. In particular, the molded body can be suitably used as automobile interior members. Specific examples of automobile interior members include console boxes, meter covers, door panels, armrests, door lock bezels, steering wheels, various switch buttons and switch bases, shift levers, center clusters, dashboards, instrument panels, in-vehicle display front panels, sensor covers, plated parts such as emblems, and garnishes.

A method for manufacturing a molded body is not particularly limited, and needs only be a molding method by which at least a portion of a molded body substrate, for example, a thermoplastic resin substrate, can be covered with a laminate. A molded body in which the laminate is placed on its surface can be manufactured using the laminate through, for example, in-mold molding, film insert injection molding, or the like. In addition, before in-mold molding or film insert injection molding, preparatory shaping may be performed on the laminate as needed using a method such as vacuum molding, pressure molding, or compression molding. Alternatively, it is also possible to perform so-called three-dimensional laminate molding, in which the laminate is applied with reduced pressure and/or increased pressure under heat, then the laminate is placed on the surface of the thermoplastic resin substrate having at least a portion having a non-flat three-dimensional shape under reduced pressure and/or increased pressure to from the molded body. Furthermore, the resin molded body may be produced by laminating the laminate on the surface of the thermoplastic resin substrate by hand while the laminate is heated and stretched by hand as appropriate.

### EXAMPLES

Hereinafter, one or more embodiments of the present invention will be described in detail based on examples. The present invention is not limited to these examples. In the following, unless otherwise specified, “parts” means “parts by mass” and “%” means “% by mass”.

Measurement methods and evaluation methods used in the examples and comparative examples will be described below.

### (Cure Index and Degree of Curing)

The cure index and the degree of curing of the cured resin layer were determined as follows: using FT/IR-4700 (manufactured by JASCO Corporation) and ATR (Attenuated Total Reflection) with use of a diamond prism, the infrared absorption spectra of the surface of the coating film (in a dry state) of the active energy ray curable resin composition before curing and the surface of the cured resin layer were measured; corrections were made for components originating from the infrared absorption spectrum of the prism material; in the infrared absorption spectra, where wavenumber (cm⁻¹) is shown on the horizontal axis and transmittance (%) is shown on the vertical axis, using the “spectrum analysis” function of the instrument, a baseline, which is a straight line connecting two points at the base of each of the infrared absorption peak at a wavenumber of about 810 cm⁻¹ and the infrared absorption peak at a wavenumber of about 1705 cm⁻¹, was set using the following method, and a numerical value corresponding to the peak area was calculated. In the infrared absorption spectra, where the wavenumber (cm⁻¹) is shown on the horizontal axis and transmittance (%) is shown on the vertical axis, a downward infrared absorption peak was observed. These values were regarded as the areas of the respective peaks, and the cure index and the degree of curing were calculated using the following formulas 1 and 2.

$$Cure index = B / D \qquad [ Formula 1 ]$$

$$Degree of curing ( \% ) = 100 \times [ ( A / C ) - ( B / D ) ] / ( A / C ) \qquad [ Formula 2 ]$$

In the formulas 1 and 2, A represents the area of the infrared absorption peak at a wavenumber of about 810 cm⁻¹ in FT-IR measurement of the coating film of the active energy ray curable resin composition before curing, B represents the area of the infrared absorption peak at a wavenumber of about 810 cm⁻¹ in FT-IR measurement of the cured resin layer, C represents the area of the infrared absorption peak at a wavenumber of about 1705 cm⁻¹ in FT-IR measurement of the coating film of the active energy ray curable resin composition before curing, and D represents the area of the infrared absorption peak at a wavenumber of about 1705 cm⁻¹ in FT-IR measurement of the cured resin layer. For A and C, in the same infrared absorption spectrum chart, the straight line connecting the two points at the base of the corresponding peak is used as the baseline, and the area of a region surrounded by the baseline and the curve of the peak is calculated as the peak area. For B and D, in the same infrared absorption spectrum chart, the straight line connecting the two points at the base of the corresponding peak is used as the baseline, and the area of a region surrounded by the baseline and the curve of the peak is calculated as the peak area. The peak at a wavenumber of about 810 cm⁻¹ corresponds to the out-of-plane bending vibration of the carbon-carbon (C—C) double bond of the acrylate group, and the peak at a wavenumber of 1705 cm⁻¹ corresponds to the stretching vibration of the carbon-oxygen (C—O) double bond of the ester group. In an infrared absorption spectrum (IR spectrum) chart, the two points at the base of a predetermined peak refer to the points where the IR spectrum lines on both sides of the peak start to bend downward toward the center of the peak.

The FIGURE shows an example of the cure index B/D determined from the IR spectrum chart for Comparative Example 2. In the FIGURE, a peak 1 is an infrared absorption peak at a wavenumber of about 810 cm⁻¹, and a peak 2 is an infrared absorption peak at a wavenumber of about 1705 cm⁻¹. For the peak 1, the numerical value corresponding to the peak area, which is the area of a region surrounded by a baseline Lb1, which is a straight line connecting the two base points a and b, and a curve of the peak 1, namely, B, is 23.5038, and for the peak 2, the numerical value corresponding to the peak area, which is the area of a region surrounded by a baseline Lb2, which is a straight line connecting the two base points c and d, and a curve of the peak 2, namely, D, is 1276.81. This results in a cure index B/D of 0.0184.

In the IR spectrum chart, the points a and b where the IR spectrum lines on both sides adjacent to the peak 1 start to bend downward toward the center of the peak 1 are the two points at the base of the peak 1, respectively. In the IR spectrum chart, the points c and d where the IR spectrum lines on both sides adjacent to the peak 2 start to bend downward toward the center of the peak 2 are the two points at the base of the peak 2, respectively.

### (Tensile Elongation at Break at 120° C.)

The acrylic resin film was cut into a piece of 10 mm (width)×100 mm (length) to prepare a test piece. For the test piece, measurement was performed using a Tensilon tension testing machine (AG-2000D manufactured by Shimadzu Corporation) equipped with a high-temperature chamber set to 120° C., under the conditions that a pre-heating time was 2 minutes, a chuck distance was 40 mm, and a tension speed was 200 mm/min. The elongation at which the acrylic resin film broke was taken as the tensile elongation at break. The value of the tensile elongation at break is the arithmetic mean value of three values excluding the highest and lowest values among the measurement results obtained using five test pieces.

### (Crack Elongation at 120° C.)

The laminate was cut into a piece of 10 mm (width)×100 mm (length) to prepare a sample. For the sample, measurement was performed using a Tensilon tension testing machine (AG-2000D manufactured by Shimadzu Corporation) equipped with a high-temperature chamber set to 120° C., under the conditions that a pre-heating time was 2 minutes, a chuck distance was 40 mm, and a tension speed was 200 mm/min. The elongation when a crack formed in the cured resin layer was regarded as the crack elongation at 120° C. The crack elongation value is the arithmetic mean value of (three) test results obtained by performing measurement on three samples.

### (Thickness)

The thickness of the acrylic resin film (film thickness) was measured using a PEACOCK dial gauge No. 25 (manufactured by Ozaki MFG. Co., Ltd.).

The thickness of the cured resin layer (film thickness) was measured using an F20 film thickness measurement system (manufactured by Filmetrics Inc.). The surface opposite to the cured resin layer was painted black with a felt tip pen, and measurement was performed with the refractive index of the acrylic resin film being set to 1.49, and the refractive index of the cured resin layer being set to 1.50.

### (Total Light Transmittance and Haze)

The total light transmittance and haze of the laminate were measured using a haze meter NDH4000 (manufactured by Nippon Denshoku Industries Co., Ltd.) according to JIS K 7375:2008 and JIS K 7136:2000, respectively.

(ΔHaze after Stretching at 120° C.)

The laminate was cut into a piece of 10 mm (width)×100 mm (length) to prepare a sample. The sample was stretched by 40% or 80% using a Tensilon tension testing machine (AG-2000D manufactured by Shimadzu Corporation) equipped with a thermostatic chamber set to 120° C., under the conditions that a pre-heating time was 2 minutes, a chuck distance was 40 mm, and a tension speed was 200 mm/min, and the haze of the stretched portion of the laminate after stretching was measured using a haze meter NDH4000 (manufactured by Nippon Denshoku Industries Co., Ltd.) according to JIS K 7136:2000. The chuck distance was 56 mm when the sample was stretched by 40%, and 72 mm when the sample was stretched by 80%. An absolute value of the difference between the haze of the laminate before stretching and the haze of the laminate after stretched by 40% or 80% was defined as “Δhaze after stretched by 40% at 120° C.” or “Δhaze after stretched by 80% at 120° C.”.

### (Pencil Hardness)

The pencil hardness of the surface of the laminate on the cured resin layer side was measured with a load of 500 g according to JIS K 5600 May 4:1999.

### (Weathering Test)

A super xenon weather meter (SX2D-75 manufactured by Suga Test Instruments Co., Ltd.) was used. The filter was configured such that quartz glass was used on the inner side and polysilicate #275 was used on the outer side, and direct sunlight was simulated. A weathering test was performed, in which a laminate sample (40 mm×50 mm) was placed such that the cured resin layer side was located on the light source side, for 300 hours or 500 hours under the following conditions.

Conditions: The irradiance was 180 W/m² (300 to 400 nm), the black panel temperature was 89° C.±3° C., the relative humidity was 50%±5%, and no rain

### (DEET Resistance Test)

A laminate sample cut into a 5 cm×5 cm square was placed on a horizontal surface such that the cured resin layer side was located on the upper side, a piece of gauze (FC Gauze, manufactured by Hakujuji Co., Ltd.) cut into a 5 cm×5 cm piece was placed thereon, and 0.05 g of insect repellent (Muhi Insect Repellent Mushipair α30, manufactured by Ikeda Mohando Co., Ltd., an alcohol solution of DEET (N,N-diethyl-3-methylbenzamide) containing 30 g of DEET per 100 mL) was dropped onto the center of the gauze and the sample was left for 30 seconds. Note that the insect repellent permeates through the gauze and comes into contact with the surface of the cured resin layer of the laminate. Thereafter, the sample was left in an oven at 74° C. for 1 hour, the gauze was removed, and any remaining chemicals (insect repellent) were wiped off with a wet cloth. The surface of the cured resin layer was visually observed and the DEET resistance was evaluated according to the following criteria.
Good: No change in appearance
Poor: A mark remained along the contour of the drop and/or the portion of the surface of the cured resin layer that came into contact with the drop turned white

### (Isopropyl Alcohol Resistance Test, Acetone Resistance Test)

A laminate sample cut into a 5 cm×5 cm square was placed on a horizontal surface such that the cured resin layer side was located on the upper side and one drop (approximately 0.02 mL) of isopropyl alcohol (also referred to as IPA hereinafter) or acetone taken with a dropper was poured thereon. The sample was then left at room temperature (23° C.) for 6 hours, the surface of the cured resin layer was then visually observed, and the chemical resistance was evaluated according to the following criteria.
Good: No change in appearance
Poor: A mark remained along the contour of the drop and/or the portion of the surface of the cured resin layer that came into contact with the drop dissolved

### (Steel Wool Wear Test)

A surface property measuring machine (HEIDON Type 14DR manufactured by Shinto Scientific Co., Ltd.) was used. Steel wool #0000 was attached to a probe with a diameter of 1 mm, and a 100 g weight was placed thereon. The steel wool was placed on the surface of the cured resin layer of the laminate, and a test was carried out with 10 reciprocating strokes at a stroke of 70 mm and a speed of 6000 mm/min. After the steel wool (SW) wear test, the presence or absence and degree of scratches on the surface of the cured resin layer of the laminate were visually observed. Furthermore, the haze value after the test was measured, and the absolute value of the difference between the haze value after the test and the haze value before the test was regarded as Δhaze.

### (Gauze Wear Test)

A both-way wear tester HEIDON Type 30S (manufactured by Shinto Scientific Co., Ltd.) was used. Gauze was attached to a probe with a diameter of 1 mm, and a 500 g weight was placed thereon. The gauze was placed on the surface of the cured resin layer of the laminate, and a test was carried out with 200 reciprocating strokes at a stroke of 100 mm and a speed of 6000 mm/min. After the test, the presence or absence and degree of scratches on the surface of the laminate were visually observed. Furthermore, the haze value after the test was measured, and the absolute value of the difference between the haze value after the test and the haze value before the test was regarded as Δhaze.

### (Adhesion Test)

Using a cutter knife, 100 squares were cut into the surface of the cured resin layer of the laminate in a grid pattern spaced 1 mm apart, penetrating the cured resin layer until they reached the surface of the acrylic resin film. Cellophane tape was then firmly pressed onto the surface from above, an edge of the tape was quickly peeled off, and the adhesion between the cured resin layer and the substrate was evaluated according to the degree of peeling of the cured resin layer according to the following criteria.
Good: The cured resin layer did not peel in any of the 100 squares
Fair: The cured resin layer peeled in some squares
Poor: The cured resin layer peeled in all of the 100 squares

### (Color Tone)

The color tone of the laminate was measured using a spectrophotometer SE7700 (manufactured by Nippon Denshoku Industries Co., Ltd.) under the following conditions, according to JIS Z 8781-4:2013. The color difference (ΔE) and YI value before and after the weathering test were calculated from XYZ values and L*a*b* values obtained by performing measurement on the laminate before and after the weathering test. Furthermore, the absolute value of the difference between the YI value after the weathering test and the YI value before the weathering test was defined as ΔYI.

Mode: transmittance, light source: D65, field of view: 2°, measurement diameter: 28 mm

### (Water Contact Angle, Oleic Acid Contact Angle)

A contact angle measuring device (model DMo-501) manufactured by Kyowa Interface Science Co., Ltd. was used to measure the contact angle by dropping water or oleic acid onto the surface of the laminate on the cured resin layer side.

### Manufacturing Example 1: Graft Copolymer Particles (A)

The following materials were introduced into an 8-L polymerizer equipped with a stirrer.
Deionized water 200 parts
Dioctyl sodium sulfosuccinate 0.24 parts
Sodium formaldehyde sulfoxylate (also known as Rongalit) 0.15 parts
2-sodium ethylenediaminetetraacetate 0.001 parts
Ferrous sulfate 0.00025 parts

The gas inside the polymerizer was thoroughly replaced with nitrogen gas to make the inside of the polymerizer substantially oxygen-free. Thereafter, an internal temperature of the polymerizer was set to 60° C. The following monomer mixture was continuously added to the polymerizer at a rate (speed) of 10 parts by mass/hour. After the addition of the monomer mixture below was completed, polymerization was continued for another 0.5 hours to obtain particles of a cross-linked elastomer (A1) (average particle size was 90 nm). The polymerization conversion rate was 99.5%. In the following description, RUVA is a reactive ultraviolet absorber (2-(2′-hydroxy-5′-methacryloyloxyethylphenyl)-2-H-benzotriazole, manufactured by Otsuka Chemical Co., Ltd., RUVA-93).

### Monomer Mixture:

Vinyl monomer mixture (n-butyl acrylate (BA) 90% and methyl methacrylate (MMA) 10%) 30 parts
RUVA 0.3 parts
Allyl methacrylate (ALMA) 0.63 parts
Cumene hydroperoxide (CHP) 0.2 parts

Then, 0.05 parts of dioctyl sodium sulfosuccinate was introduced into the polymerizer containing particles of the cross-linked elastomer (A1). Then, the internal temperature of the polymerizer was adjusted to 60° C., and a monomer mixture containing 70 parts of vinyl monomer mixture (MMA: 98%, BA: 1%, and RUVA: 1%) for forming a graft polymer layer (A2), 0.5 parts of t-dodecyl mercaptan, and 0.5 parts of CHP was continuously added to the polymerizer at a rate of 10 parts/hour. The polymerization was continued for another 1 hour to obtain the latex of graft copolymer particles (A) (average particle size was 90 nm). The polymerization conversion rate was 98.2%. The obtained latex was salted out and coagulated with calcium chloride, and the coagulated solid was washed with water and dried to obtain powdery graft copolymer particles (A).

### Manufacturing Example 2: Graft Copolymer Particles (B)

The following materials were introduced into an 8-L polymerizer equipped with a stirrer, and stirring was started.
Deionized water 175 parts
Polyoxyethylene lauryl ether phosphate 0.01 parts
Boric acid 0.4725 parts
Sodium carbonate 0.04725 parts

The internal temperature of the polymerizer was set to 80° C., and gas inside the polymerizer was thoroughly replaced with nitrogen gas to make the inside of the polymerizer substantially oxygen-free. After the internal temperature of the polymerizer reached 80° C., a mixture liquid containing 7 parts of a vinyl monomer mixture (MMA: 97% and BA: 3%), 0.035 parts of allyl methacrylate, and 0.02 parts of t-dodecyl mercaptan was introduced into the polymerizer. Thereafter, 0.03 parts of t-butyl hydroperoxide was introduced into the polymerizer. After 5 minutes, 0.065 parts of sodium formaldehyde sulfoxylate was added as a 5% aqueous solution. After 10 minutes, 0.05 parts of t-butyl hydroperoxide was introduced. After another 15 minutes, 0.01 parts of sodium hydroxide was added as a 2% aqueous solution.

Then, a mixture containing 20 parts of a vinyl monomer mixture (MMA: 97% and BA: 3%), 0.1 parts of allyl methacrylate, 0.07 parts of t-dodecyl mercaptan, and 0.085 parts of polyoxyethylene lauryl ether phosphate was continuously added to the polymerizer over 60 minutes. Five minutes after the completion of the continuous addition, 0.003 parts of t-butyl hydroperoxide was introduced. The polymerization was continued for another 30 minutes to obtain particles of a hard cross-linked polymer that would become a first layer of a core (cross-linked elastomer (B1)). The polymerization conversion rate was 99.0%.

Then, 0.027 parts of sodium hydroxide was added to the polymerizer as a 2% aqueous solution. Thereafter, 0.08 parts of potassium persulfate was added to the polymerizer as a 2% aqueous solution. A mixture liquid containing 50 parts of a vinyl monomer mixture (BA: 82% and styrene (St): 18%) and 0.375 parts of allyl methacrylate was continuously added to the polymerizer over 150 minutes. After the addition was completed, 0.015 parts of potassium persulfate was added to the polymerizer as a 2% aqueous solution. The polymerization was continued for 120 minutes to obtain a core layer polymer having a two-layer structure containing a hard cross-linked resin layer and a cross-linked elastomer layer. The polymerization conversion rate was 99.0%, and the average particle size was 225 nm.

Thereafter, 0.03 parts of potassium persulfate was added to the polymerizer as a 2% aqueous solution. Then, 15 parts of a vinyl monomer mixture (MMA: 97% and BA: 3%) for the first shell layer was continuously added to the polymerizer over 45 minutes. After further polymerization for 30 minutes, 8 parts of a vinyl monomer mixture (MMA: 55% and BA: 45%) for the second shell layer was continuously added to the polymerizer over 20 minutes. Polymerization was continued for another 60 minutes to obtain the latex of graft copolymer particles (B) having a core layer having a two-layer structure and two shell layers. The polymerization conversion rate was 100.0%. The obtained latex was salted out and coagulated with magnesium chloride, and the coagulated solid was then washed with water and dried to obtain powdery graft copolymer particles (B). The graft copolymer particles (B) had an average particle size of 240 nm.

### Manufacturing Example 3: Acrylic Resin Film

30 parts of the powdery graft copolymer particles (A) obtained in Manufacturing Example 1, 4 parts of the powdery graft copolymer particles (B) obtained in Manufacturing Example 2, 66 parts of PARAPET HM (polymethyl methacrylate; 100% methyl methacrylate manufactured by Kuraray Co., Ltd.), and 0.6 parts of a hindered phenol-based antioxidant (“AO60” manufactured by ADEKA Corporation) were mixed using a Henschel mixer. Then, the resulting mixture was melt-kneaded at a screw rotation speed of 150 rpm and a discharge amount of 180 kg/hr using a 58 mm@ vented co-rotating twin-screw extruder (TEM58 manufactured by Toshiba Machine Co., Ltd., L/D=41.7) equipped with a leaf disc polymer filter (manufactured by Nagase & Co., Ltd., filtration accuracy 10 μm, size was 7 inches, 33 filters) between the die and the extruder head with a cylinder temperature adjusted to 190° C. to 250° C., and then taken up from the extruder in the form of strands, cooled, and then cut into pellets. The obtained pellets were melt-kneaded using a 90 mmΦ single-screw extruder with a T-die at a cylinder setting temperature of 180° C. to 240° C. and a discharge rate of 150 kg/hr, and extruded from the T-die at a die temperature of 240° C. Both sides of the resultant were brought into contact with a metallic casting roll whose temperature was adjusted to 90° C. and a touch roll equipped with an elastic metal sleeve adjusted to 60° C., and the resultant was cooled and solidified while forming a film and wound up to obtain an acrylic resin film with a thickness of 75 μm. The tensile elongation at break of the acrylic resin film at 120° C. measured as described above was 220%.

### Manufacturing Example 4: Coating Material

A curable resin composition containing a urethane acrylate resin (product name “P-5820TAH-1” manufactured by Daido Chemical Corporation, containing a urethane acrylate resin as a main component, a small amount of acrylic acid ester, a trace amount of aluminum oxide nanoparticles (inorganic fineparticles), and a photopolymerization initiator, the solid concentration was 30% by mass, the solvent: a mixed solvent of methyl ethyl ketone, propylene glycol, and methyl isobutyl ketone, and simply referred to as “P-5820TAH-1” hereinafter) was diluted with methyl ethyl ketone to have a solid concentration of 24% by mass. To 100 parts of the solid content of the obtained resin composition, 0.5 parts of reactive HALS (product name “ADK STAB LA-82” manufactured by ADEKA Corporation, also referred to as “LA-82” hereinafter) and 0.3 parts of a fluorine-containing acrylic compound (product name “KY-1203” manufactured by Shin-Etsu Chemical Co., Ltd., the solid concentration was 20%, the solvent: a mixed solvent of methyl ethyl ketone and methyl isobutyl ketone, and simply referred to as “KY-1203” hereinafter) serving as the solid content were added, and the mixture was stirred to obtain a coating material 1.

Coating materials 2, 3, and 7 were produced in the same manner as in the case of coating material 1, except that the blend amount of LA-82 and KY-1203 was as shown in Table 1 below.

Coating materials 4 to 6, and 8 and 9 were produced in the same manner as in the case of the coating material 1, except that a curable resin composition containing a urethane acrylate resin (product name “P-5820TA-20J” manufactured by Daido Chemical Corporation, containing a urethane acrylate resin as a main component and small amounts of acrylic acid ester and a photopolymerization initiator, the solid content was 24%, the solvent: a mixed solvent of methyl ethyl ketone, propylene glycol, and methyl isobutyl ketone, and simply referred to as “P-5820TA-20J” hereinafter) was used, and the amounts of LA-82 and KY-1203 blended in 100 parts of the solid content of the resin composition was as shown in Table 1 below.

P-5820TA-20J was used as is as a coating material 10.

TABLE 1

| | Blend Amount (parts by mass) | | | |
|---|---|---|---|---|
| Coating | P-5820TAH-1 | P-5820TA-20J | | |
| Material | (as solid content) | (as solid content) | KY-1203 | LA-82 |
| 1 | 100 | 0 | 0.3 | 0.5 |
| 2 | 100 | 0 | 0.3 | 1.0 |
| 3 | 100 | 0 | 0.3 | 2.0 |
| 4 | 0 | 100 | 0.3 | 0.5 |
| 5 | 0 | 100 | 0.3 | 1.0 |
| 6 | 0 | 100 | 0.3 | 2.0 |
| 7 | 100 | 0 | 0.3 | 0.0 |
| 8 | 0 | 100 | 0.3 | 0.0 |
| 9 | 0 | 100 | 0 | 2.0 |
| 10 | 0 | 100 | 0 | 0 |

### Example 1

The coating material 1 was applied onto the acrylic resin film obtained in Manufacturing Example 3 using a bar coater to form a curable resin layer on the acrylic resin film. Subsequently, the curable resin layer was dried at 80° C. for 1 minute to volatilize the solvent from the curable resin layer. Then, the dried curable resin layer (the coating film of the active energy ray curable resin composition before curing) was irradiated with ultraviolet rays at the integrated light quantity of UV irradiation shown in Table 2 to cure the curable resin layer, thereby forming a cured resin layer (a cured product of active energy ray curable resin composition) having a thickness shown in Table 2 below, and a laminate was obtained. The temperature of the cooling roll when the cured resin layer was formed was 50° C.

### Examples 2 to 9

A laminate was produced in the same manner as in Example 1, except that the coating material shown in Table 2 below was used.

### Examples 10 and 11

A laminate was produced in the same manner as in Example 1, except that the coating material shown in Table 2 below was used and the thickness of the cured resin layer was set as shown in Table 2 below.

### Comparative Example 1

A laminate was produced in the same manner as in Example 6, except that the integrated light quantity of UV irradiation was set as shown in Table 2 below.

### Comparative Example 2

A laminate was produced in the same manner as in Example 1, except that the coating material shown in Table 2 below was used, and the thickness of the cured resin layer and the integrated light quantity of UV irradiation were set as shown in Table 2 below.

Various physical properties (initial state) of the laminates obtained in the examples and the comparative examples were measured and evaluated as described above, and the results are shown in Table 2 below. The weathering test was performed using the laminates obtained in the examples and the comparative examples, and various physical properties of the laminates were measured and evaluated as described above, and the results are shown in Table 3 below. In Table 3 below, 300 hours refer to physical properties of the laminate after 300 hours of the weathering test, and 500 hours refer to physical properties of the laminate after 500 hours of the weathering test. In Table 3 below, the blend amounts of reactive HALS and fluorine-containing acrylic compound in the coating material are expressed in parts by mass relative to 100 parts by mass of the solid content (urethane acrylate resin) in the coating material.

TABLE 2

| | | | Ex. | | | | | | |
|---|---|---|---|---|---|---|---|---|---|
| | | | 1 | 2 | 3 | 4 | 5 | 6 | 7 |
| Coating Material | | No. | 1 | 2 | 3 | 4 | 5 | 6 | 9 |
| Thickness of cured resin layer | | μm | 3.5 | 3.5 | 3.5 | 3.5 | 3.5 | 3.5 | 3.5 |
| Integrated light quantity of UV irradiation | | | 650 | 650 | 650 | 650 | 650 | 650 | 650 |
| Initial | Total light transmittance | % | 92.1 | 92.1 | 92.2 | 92.2 | 92.1 | 92.1 | 92.1 |
| | Haze | % | 0.4 | 0.4 | 0.3 | 0.4 | 0.3 | 0.5 | 0.4 |
| | Color tone | L* | 96.7 | 96.8 | 96.7 | 96.8 | 96.8 | 96.7 | 96.8 |
| | | a* | −0.1 | −0.1 | −0.1 | −0.1 | −0.1 | −0.1 | 0.1 |
| | | b* | 0.4 | 0.4 | 0.4 | 0.4 | 0.4 | 0.5 | 0.4 |
| | | YI | 0.7 | 0.7 | 0.8 | 0.8 | 0.7 | 0.8 | 0.7 |
| | Water contact angle | ° | 108 | 109 | 110 | 109 | 107 | 108 | 75 |
| | Oleic acid contact angle | ° | 75 | 75 | 73 | 75 | 74 | 74 | 16 |
| | DEET resistance | | Good | Good | Good | Good | Good | Good | Good |
| | IPA resistance | | Good | Good | Good | Good | Good | Good | Good |
| | Acetone resistance | | Good | Good | Good | Good | Good | Good | Good |
| | Adhesion | | Good | Good | Good | Good | Good | Good | Good |
| | Pensile hardness | | H | H | H | H | H | H | H |
| | SW wear test | Visual | Scratches | Scratches | Scratches | Severe | Severe | Severe | Severe |
| | | observation | | | | scratches | scratches | scratches | scratches |
| | | Δhaze (%) | 0.6 | 1 | 1.4 | 4.2 | 7.1 | 4.6 | 9.5 |
| | Gauze wear test | Visual | No | No | No | No | No | No | Scratches |
| | | observation | scratches | scratches | scratches | scratches | scratches | scratches | |
| | | Δhaze (%) | −0.2 | −0.2 | −0.1 | 0 | −0.3 | −0.1 | 1.1 |
| | Crack elongation at 120° C. | % | 90 | 80 | 80 | 90 | 80 | 80 | 80 |
| | Δhaze when stretched by 40% | % | −0.1 | 0 | 0 | 0.1 | −0.2 | −0.1 | 0 |
| | at 120° C. | | | | | | | | |
| | Δhaze when stretched by 80% | % | 0 | 0.4 | 0.2 | 0.1 | −0.1 | 0 | 0.2 |
| | at 120° C. | | | | | | | | |
| | Degree of curing | % | 84 | 80 | 88 | 79 | 77 | 79 | 78 |
| | Cure index | | 0.0077 | 0.0098 | 0.0059 | 0.0103 | 0.0111 | 0.01 | 0.0104 |

| | | | Ex. | | | | Comp. Ex. | |
|---|---|---|---|---|---|---|---|---|
| | | | 8 | 9 | 10 | 11 | 1 | 2 |
| Coating Material | | No. | 7 | 8 | 7 | 7 | 6 | 10 |
| Thickness of cured resin layer | | μm | 3.5 | 3.5 | 2.5 | 2 | 3.5 | 4 |
| Integrated light quantity of UV irradiation | | | 650 | 650 | 650 | 650 | 460 | 460 |
| Initial | Total light transmittance | % | 92 | 92.1 | 92.1 | 92.2 | 92.1 | 92 |
| | Haze | % | 0.4 | 0.3 | 0.5 | 0.8 | 0.5 | 0.4 |
| | Color tone | L* | 96.6 | 96.7 | 96.7 | 96.6 | 96.5 | 96.7 |
| | | a* | −0.1 | −0.1 | −0.1 | −0.1 | 0.1 | −0.1 |
| | | b* | 0.4 | 0.5 | 0.5 | 0.5 | 0.3 | 0.4 |
| | | YI | 0.8 | 0.8 | 0.8 | 0.8 | 0.8 | 0.8 |
| | Water contact angle | ° | 107 | 108 | 110 | 106 | 108 | 75 |
| | Oleic acid contact angle | ° | 75 | 74 | 75 | 73 | 73 | 16 |

| | | | | | | |
|---|---|---|---|---|---|---|
| DEET resistance | Good | Good | Good | Good | Poor | Poor |
| IPA resistance | Good | Good | Good | Good | Good | Good |
| Acetone resistance | Good | Good | Good | Good | Good | Good |
| Adhesion | Good | Good | Good | Good | Good | Good |
| Pensile hardness | H | H | H | H | F-H | F-H |

| | | | | | | | |
|---|---|---|---|---|---|---|---|
| SW wear test | Visual | Scratches | Severe | Scratches | Scratches | Severe | Severe |
| | observation | | scratches | | | scratches | scratches |
| | Δhaze (%) | 1.3 | 8.4 | 0.2 | 0.5 | 12 | 12.2 |
| Gauze wear test | Visual | No | No | No | No | Scratches | Scratches |
| | observation | scratches | scratches | scratches | scratches | | |
| | Δhaze (%) | 0.1 | 0.3 | −0.4 | −0.2 | 1.5 | 1.3 |
| Crack elongation at 120° C. | % | 90 | 80 | 90 | 90 | 120 | 120 |
| Δhaze when stretched by 40% | % | 0 | 0 | 0 | 0 | 0 | 0 |
| at 120° C. | | | | | | | |
| Δhaze when stretched by 80% | % | 0.2 | 0.2 | 0 | 0 | 0 | 0 |
| at 120° C. | | | | | | | |
| Degree of curing | % | 85 | 78 | 84 | 76 | 60 | 62 |
| Cure index | | 0.007 | 0.0104 | 0.0079 | 0.0115 | 0.0193 | 0.0184 |

TABLE 3

| | | | Ex. | | | | |
|---|---|---|---|---|---|---|---|
| | | | 1 | 2 | 3 | 4 | 5 |
| Coating | No. | | 1 | 2 | 3 | 4 | 5 |
| Material | Reactive HALS | parts by | 0.5 | 1 | 2 | 0.5 | 1 |
| | | mass | | | | | |
| | Fluorine-containing acrylic | parts by | 0.3 | 0.3 | 0.3 | 0.3 | 0.3 |
| | compound | mass | | | | | |
| 300 hr | Total light transmittance | % | 92.1 | 91.9 | 92.1 | 92.1 | 92.1 |
| | Haze | % | 0.4 | 0.6 | 0.4 | 0.3 | 0.4 |
| | Color tone | L* | 96.8 | 96.7 | 96.8 | 96.8 | 96.8 |
| | | a* | −0.1 | −0.1 | 0 | −0.1 | 0 |
| | | b* | 0.4 | 0.5 | 0.4 | 0.4 | 0.4 |
| | | ΔE | 0.1 | 0.1 | 0.1 | 0.1 | 0.1 |
| | | YI | 0.8 | 0.9 | 0.8 | 0.8 | 0.7 |
| | | ΔYI | 0 | 0.2 | 0.1 | 0 | 0 |
| | Water contact angle | ° | 98 | 97 | 97 | 98 | 98 |
| | DEET resistance | | Good | Good | Good | Good | Good |
| | Adhesion | | Good | Good | Good | Good | Good |
| 500 hr | Total light transmittance | % | 92 | 92 | 92.1 | 91.9 | 92 |
| | Haze | % | 0.5 | 0.6 | 0.5 | 1.1 | 0.7 |
| | Color tone | L* | 96.5 | 96.7 | 96.7 | 96.6 | 96.7 |
| | | a* | 0 | −0.1 | 0 | 0 | 0 |
| | | b* | 0.5 | 0.4 | 0.4 | 0.5 | 0.5 |
| | | ΔE | 0.2 | 0.1 | 0 | 0.2 | 0.1 |
| | | YI | 0.8 | 0.8 | 0.8 | 0.9 | 0.9 |
| | | ΔYI | −0.1 | −0.1 | 0 | 0.1 | 0.2 |
| | Water contact angle | ° | 98 | 97 | 94 | 96 | 94 |

| | | | | | |
|---|---|---|---|---|---|
| DEET resistance | Poor | Good | Good | Poor | Good |
| Adhesion | Good | Good | Good | Good | Good |

| | | | Ex. | | | | | |
|---|---|---|---|---|---|---|---|---|
| | | | 6 | 7 | 8 | 9 | 10 | 11 |
| Coating | No. | | 6 | 9 | 7 | 8 | 7 | 7 |
| Material | Reactive HALS | parts by | 2 | 2 | 0 | 0 | 0 | 0 |
| | | mass | | | | | | |
| | Fluorine-containing acrylic | parts by | 0.3 | 0 | 0.3 | 0.3 | 0.3 | 0.3 |
| | compound | mass | | | | | | |
| 300 hr | Total light transmittance | % | 92 | 92 | 92 | 92.1 | 92.1 | 92 |
| | Haze | % | 0.6 | 0.6 | 0.4 | 0.3 | 0.4 | 0.7 |
| | Color tone | L* | 96.8 | 96.8 | 96.7 | 96.7 | 96.7 | 96.7 |
| | | a* | −0.1 | 0 | −0.1 | −0.1 | −0.1 | −0.1 |
| | | b* | 0.4 | 0.4 | 0.4 | 0.4 | 0.5 | 0.4 |
| | | ΔE | 0 | 0.1 | 0.1 | 0 | 0 | 0.1 |
| | | YI | 0.8 | 0.7 | 0.8 | 0.8 | 0.9 | 0.8 |
| | | ΔYI | 0.1 | 0 | 0 | 0 | 0.1 | 0 |
| | Water contact angle | ° | 98 | 71 | 98 | 98 | 98 | 92 |
| | DEET resistance | | Good | Poor | Poor | Poor | Poor | Poor |
| | Adhesion | | Good | Not | Good | Good | Good | Good |
| | | | | measured | | | | |
| 500 hr | Total light transmittance | % | 92 | Not | 92 | 92.1 | 92 | 92 |
| | Haze | % | 0.6 | measured | 0.9 | 0.6 | 0.4 | 0.7 |
| | Color tone | L* | 96.6 | | 96.4 | 96.7 | 96.7 | 96.7 |
| | | a* | 0 | | −0.1 | −0.1 | 0 | 0 |
| | | b* | 0.4 | | 0.5 | 0.4 | 0.4 | 0.4 |
| | | ΔE | 0.1 | | 0.2 | 0.1 | 0.1 | 0.1 |
| | | YI | 0.8 | | 0.8 | 0.7 | 0.7 | 0.8 |
| | | ΔYI | 0.1 | | −0.1 | 0.1 | 0.1 | 0 |
| | Water contact angle | ° | 96 | | 98 | 95 | 95 | 91 |

| | | | | | |
|---|---|---|---|---|---|
| DEET resistance | Good | Poor | Poor | Poor | Poor |
| Adhesion | Good | Good | Good | Good | Good |

As can be seen from Table 2 above, the laminates of the examples had excellent transparency, favorable surface hardness and scratch resistance, excellent secondary moldability, and favorable DEET resistance. The laminates of Examples 1 to 3, 8, 10, and 11 in which the cured resin layer contained inorganic fine particles had excellent steel wool wear resistance and gauze wear resistance.

On the other hand, the laminates of the comparative examples in which the cure index of the cured resin layer exceeded 0.013 had inferior DEET resistance. In the laminates of the comparative examples, the degree of curing of the cured resin layer was less than 75.

As can be seen from Table 3 above, the laminates of Examples 1 to 6, in which the cured resin layer was formed from a cured product of an active energy ray curable resin composition containing a hindered amine light stabilizer having a reactive functional group and a compound having a hydrophobic group and a reactive functional group, that is, the curable resin layer was formed from a cured product of an active energy ray curable resin composition containing a urethane acrylate resin, a hindered amine light stabilizer having a reactive functional group, and a compound having a hydrophobic group and a reactive functional group, also had favorable DEET resistance after the 300-hour weathering test. In particular, the laminates of Examples 2, 3, 5, and 6, which contained the reactive HALS in an amount of more than 0.5 parts by mass with respect to 100 parts by mass of the urethane acrylate resin, also had favorable DEET resistance after the 500-hour weathering test.

On the other hand, the laminates of Examples 7 to 11, in which the curable resin layer contained only one of a hindered amine light stabilizer having a reactive functional group and a compound having a hydrophobic group and a reactive functional group, had favorable initial DEET resistance but inferior DEET resistance after the weathering test.

The present invention is not particularly limited, and may include, for example, the following embodiments.

[1] A laminate including: a substrate layer; and a cured resin layer,
wherein the substrate layer includes an acrylic resin film,
the acrylic resin film has a tensile elongation at break of 200% or more at 120° C.,
the cured resin layer is formed from a cured product of an active energy ray curable resin composition containing a urethane acrylate resin,
a cure index of the cured resin layer represented by a formula 1 below is 0.013 or less, and
the laminate has a tensile crack elongation of 80% or more at 120° C.,

$$Cure index = B / D \qquad [ Formula 1 ]$$

in the formula 1 above, B represents an area of an infrared absorption peak at a wavenumber of about 810 cm⁻¹ in FT-IR measurement of the cured resin layer, and D represents an area of an infrared absorption peak at a wavenumber of about 1705 cm⁻¹ in FT-IR measurement of the cured resin layer.

[2] The laminate according to [1], wherein the active energy ray curable resin composition further contains a hindered amine light stabilizer having a reactive functional group, and a compound having a hydrophobic group and a reactive functional group.

[3] The laminate according to [2], wherein the reactive functional group includes one or more selected from the group consisting of a methacryloyl group and an acryloyl group.

[4] The laminate according to [2] or [3], wherein the compound having the hydrophobic group and the reactive functional group is a fluorine compound having a reactive functional group or a silicone compound having a reactive functional group.

[5] The laminate according to any one of [2] to [4], wherein the compound having the hydrophobic group and the reactive functional group is a fluorine compound having a reactive functional group.

[6] The laminate according to any one of [2] to [5], wherein a ratio of the hindered amine light stabilizer having the reactive functional group relative to 100 parts by mass of the urethane acrylate resin is 1 to 10 parts by mass.

[7] The laminate according to any one of [2] to [6], wherein a ratio of the compound having the hydrophobic group and the reactive functional group relative to 100 parts by mass of the urethane acrylate resin is 0.1 to 5 parts by mass.

[8] The laminate according to any one of [1] to [7], wherein a degree of curing of the cured resin layer represented by a formula 2 below is 75% or more,

$$Degree of curing ( \% ) = 100 \times [ ( A / C ) - ( B / D ) ] / ( A / C ) \qquad [ Formula 2 ]$$

in the formula 2, A represents an area of an infrared absorption peak at a wavenumber of about 810 cm⁻¹ in FT-IR measurement of a coating film of the active energy ray curable resin composition before curing, B represents the area of the infrared absorption peak at a wavenumber of about 810 cm⁻¹ in FT-IR measurement of the cured resin layer, C represents an area of an infrared absorption peak at a wavenumber of about 1705 cm⁻¹ in FT-IR measurement of the coating film of the active energy ray curable resin composition before curing, and D represents the area of the infrared absorption peak at a wavenumber of about 1705 cm⁻¹ in FT-IR measurement of the cured resin layer.

[9] The laminate according to any one of [1] to [8], wherein a water contact angle on a surface of the cured resin layer of the laminate is 105° or more.

[10] The laminate according to any one of [1] to [9], wherein an oleic acid contact angle on a surface of the cured resin layer of the laminate is 65° or more.

[11] The laminate according to any one of [1] to [10], wherein an appearance of the laminate has no visible change when gauze coated with 0.05 g of an insect repellent containing a 30 w/v % ethanol solution of N,N-diethyl-3-methylbenzamide is placed on a surface of the cured resin layer of the laminate, and the laminate is left for 30 seconds under conditions of 23° C. and a relative humidity of 65%, and then left standing in a thermostatic chamber at 74° C. for 1 hour.

[12] The laminate according to any one of [1] to [11], wherein an appearance of the laminate has no visible change when a weathering test in which the laminate is placed such that the cured resin layer side is located on a light source side, and a xenon lamp is used as a light source is performed for 500 hours under conditions of irradiance of 180 W/m² (300 to 400 nm) with a black panel temperature of 89° C. and no rain, and gauze coated with 0.05 g of an insect repellent containing a 30% ethanol solution of N,N-diethyl-3-methylbenzamide is then placed on a surface of the cured resin layer of the laminate, the laminate is left for 30 seconds under conditions of 23° C. and a relative humidity of 65%, and the laminate is then left standing for 1 hour in a thermostatic chamber at 74° C.

[13] The laminate according to any one of [1] to [12], wherein the laminate has a haze value change of 0.5% or less before and after stretched by 80% at 120° C.

[14] The laminate according to any one of [1] or [13], wherein an appearance of the laminate has no visible change when about 0.02 mL of isopropyl alcohol or acetone is dropped onto a surface of the cured resin layer and is left at 23° C. for 6 hours.

[15] The laminate according to any one of [1] to [14], wherein the laminate has a haze change of 0.5% or less before and after a wear resistance test in which gauze is moved back and forth 20 times against a surface of the cured resin layer of the laminate under a load of 500 g/cm².

[16] The laminate according to any one of [1] to [15], wherein the laminate has a haze change of 2% or less before and after a wear resistance test in which steel wool (#0000) is moved back and forth 10 times against a surface of the cured resin layer of the laminate under a load of 100 g/cm².

[17] The laminate according to any one of [1] to [16], wherein a color difference ΔE of the laminate is less than 0.5 after a weathering test in which the laminate is placed such that the cured resin layer side is located on a light source side, and a xenon lamp is used as a light source is performed for 500 hours under conditions of irradiance of 180 W/m² (300 to 400 nm) with a black panel temperature of 89° C. and no rain.

[18] The laminate according to any one of [1] to [17], wherein the laminate is used to decorate and/or protect a molded body.

[19] The laminate according to [18], further comprising one or more layers selected from the group consisting of a printing layer, a decorative layer, an adhesive layer, an antistatic layer, a thermoplastic resin layer, and an optically functional layer.

[20] A molded body comprising: the laminate according to any one of [1] to [19]; and a molded body substrate,
wherein the laminate is laminated on a surface of the molded body substrate, and the cured resin layer of the laminate is disposed on a surface side of the molded body relative to the substrate layer of the laminate.

[21] The molded body according to [20], wherein the surface of the molded body substrate on which the laminate is laminated has a three-dimensional shape.

[22] A method for manufacturing the molded body according to [20], comprising laminating the laminate according to any one of [1] to on the surface of the molded body substrate using one or more methods selected from the group consisting of vacuum molding, pressure molding, film insert injection molding, and three-dimensional lamination molding.

The embodiments described above are not independent of each other, and those skilled in the art can combine them as appropriate without the need for over-explanation. Furthermore, constituent elements of different embodiments may be combined as appropriate.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A laminate comprising:
a substrate layer; and
a cured resin layer,
wherein:
the substrate layer includes an acrylic resin film,
the acrylic resin film has a tensile elongation at break of 200% or more at 120° C.,
the cured resin layer is formed from a cured product of an active energy ray curable resin composition containing a urethane acrylate resin,
a cure index of the cured resin layer represented by Formula 1 below is 0.013 or less, and
the laminate has a tensile crack elongation of 80% or more at 120° C.,
$$Cure index = B / D \qquad [ Formula 1 ]$$
in the Formula 1 above,
B represents an area of an infrared absorption peak at a wavenumber of 810 cm⁻¹ in FT-IR measurement of the cured resin layer, and
D represents an area of an infrared absorption peak at a wavenumber of 1705 cm⁻¹ in the FT-IR measurement of the cured resin layer.

2. The laminate according to claim 1, wherein the active energy ray curable resin composition further comprises a hindered amine light stabilizer having a reactive functional group, and a compound having a hydrophobic group and a reactive functional group.

3. The laminate according to claim 2, wherein the reactive functional group comprises one or more selected from the group consisting of a methacryloyl group and an acryloyl group.

4. The laminate according to claim 2, wherein the compound having the hydrophobic group and the reactive functional group is a fluorine compound having a reactive functional group or a silicone compound having a reactive functional group.

5. The laminate according to claim 2, wherein the compound having the hydrophobic group and the reactive functional group is a fluorine compound having a reactive functional group.

6. The laminate according to claim 2, wherein a ratio of the hindered amine light stabilizer having the reactive functional group relative to 100 parts by mass of the urethane acrylate resin is 1 to 10 parts by mass.

7. The laminate according to claim 2, wherein a ratio of the compound having the hydrophobic group and the reactive functional group relative to 100 parts by mass of the urethane acrylate resin is 0.1 to 5 parts by mass.

8. The laminate according to claim 1,
wherein a degree of curing of the cured resin layer represented by Formula 2 below is 75% or more,
$$Degree of curing ( \% ) = 100 \times [ ( A / C ) - ( B / D ) ] / ( A / C ) \qquad [ Formula 2 ]$$
in the Formula 2:
A represents an area of an infrared absorption peak at the wavenumber of 810 cm⁻¹ in the FT-IR measurement of a coating film of the active energy ray curable resin composition before curing,
B represents the area of the infrared absorption peak at the wavenumber of 810 cm⁻¹ in the FT-IR measurement of the cured resin layer,
C represents an area of an infrared absorption peak at the wavenumber of 1705 cm⁻¹ in the FT-IR measurement of the coating film of the active energy ray curable resin composition before curing, and
D represents the area of the infrared absorption peak at the wavenumber of 1705 cm⁻¹ in the FT-IR measurement of the cured resin layer.

9. The laminate according to claim 1,
wherein a water contact angle on a surface of the cured resin layer of the laminate is 105° or more, or
wherein an oleic acid contact angle on the surface of the cured resin layer of the laminate is 65° or more.

10. The laminate according to claim 1, wherein an appearance of the laminate has no visible change under the following conditions:
gauze coated with 0.05 g of an insect repellent containing a 30 w/v % ethanol solution of N,N-diethyl-3-methylbenzamide is placed on a surface of the cured resin layer of the laminate, and
the laminate is left for 30 seconds under conditions of 23° C. and a relative humidity of 65%, and then left standing in a thermostatic chamber at 74° C. for 1 hour.

11. The laminate according to claim 1, wherein an appearance of the laminate has no visible change under the following conditions:
a weathering test, in which the laminate is placed such that a cured resin layer side is located on a light source side and a xenon lamp is used as a light source, is performed for 500 hours under conditions of:
irradiance of 180 W/m² at a wavelength in a range of from 300 to 400 nm, with a black panel temperature of 89° C., and
no rain,
gauze coated with 0.05 g of an insect repellent containing a 30% ethanol solution of N,N-diethyl-3-methylbenzamide is then placed on a surface of the cured resin layer of the laminate, and
the laminate is left for 30 seconds under conditions of 23° C. and a relative humidity of 65%, and then left standing in a thermostatic chamber at 74° C. for 1 hour.

12. The laminate according to claim 1, wherein the laminate has a haze value change of 0.5% or less before and after the laminate is stretched by 80% at 120° C.

13. The laminate according to claim 1, wherein an appearance of the laminate has no visible change under the following conditions:
0.02 mL of isopropyl alcohol or acetone is dropped onto a surface of the cured resin layer and is left at 23° C. for 6 hours.

14. The laminate according to claim 1,
wherein the laminate has a haze change of 0.5% or less before and after a wear resistance test in which gauze is moved back and forth 20 times against a surface of the cured resin layer of the laminate under a load of 500 g/cm², or
wherein the laminate has a haze change of 2% or less before and after a wear resistance test in which #0000 grade steel wool is moved back and forth 10 times against the surface of the cured resin layer of the laminate under a load of 100 g/cm².

15. The laminate according to claim 1, wherein a color difference ΔE of the laminate is less than 0.5 after a weathering test, in which the laminate is placed such that a cured resin layer side is located on a light source side and a xenon lamp is used as a light source, is performed for 500 hours under conditions of:
irradiance of 180 W/m² at a wavelength in a range of from 300 to 400 nm, with a black panel temperature of 89° C., and
no rain.

16. The laminate according to claim 1, wherein the laminate is used to decorate and/or protect a molded body.

17. The laminate according to claim 16, further comprising one or more layers selected from the group consisting of a printing layer, a decorative layer, an adhesive layer, an antistatic layer, a thermoplastic resin layer, and an optically functional layer.

18. A molded body comprising:
the laminate according to claim 1; and
a molded body substrate,
wherein the laminate is laminated on a surface of the molded body substrate, and the cured resin layer of the laminate is located on a surface side of the molded body relative to the substrate layer of the laminate.

19. The molded body according to claim 18, wherein the surface of the molded body substrate on which the laminate is laminated has a three-dimensional shape.

20. A method for manufacturing the molded body according to claim 18, comprising laminating the laminate on the surface of the molded body substrate by one or more methods selected from the group consisting of vacuum molding, pressure molding, film insert injection molding, and three-dimensional lamination molding.
